(19) United States
(12) Patent Application Publication
(10) Pub. No.: US 2008/0206562 A1
(43) Pub. Date: Aug. 28, 2008

(54) METHODS OF GENERATING SUPPORTED NANOCATALYSTS AND COMPOSITIONS THEREOF

(75) Inventors: Galen D. Stucky, Santa Barbara, CA (US); Nanfeng Zheng, Xiamen (CN)

Correspondence Address: BUCHANAN, INGERSOLL & ROONEY LLP, P.O. BOX 1404, ALEXANDRIA, VA, 22313-1404, US

(73) Assignee: THE REGENTS OF THE UNIVERSITY OF CALIFORNIA, Oakland, CA (US)

(21) Appl. No.: 12/013,436

(22) Filed: Jan. 12, 2008

Related U.S. Application Data
(60) Provisional application No. 60/884,668, filed on Jan. 12, 2007.

(51) Int. Cl. B32B 15/02; C23F 1/00; B29B 9/00; B29B 9/16; B01J 31/06; B01J 21/04; B01J 21/08; B01J 23/34; B01J 29/00; B01J 21/18; B01J 27/06; B01J 23/42; B01J 23/44; B01J 23/50; B01J 23/52; B01J 27/02; B01J 27/24; B01J 31/02; B01J 23/755; B01J 31/26

(52) U.S. Cl. 428/403; 216/55; 428/402; 264/5; 264/7; 502/100; 502/300; 502/159; 502/355; 502/350; 502/232; 502/80; 502/349; 502/340; 502/87; 502/180; 502/181; 502/325; 502/337; 502/339; 502/168; 502/167; 502/200; 502/150; 502/216; 216/83; 502/344; 502/347; 502/345; 502/171

(57) ABSTRACT

The disclosure relates to metal nanoparticle compositions and methods of making such nanoparticle compositions that are useful for the production of electrically conductive features and catalysts.

### CROSS-REFERENCE TO RELATED APPLICATIONS

This application claims the benefit of U.S. Provisional Application Ser. No. 60/884,668, filed on Jan. 12, 2007, the disclosure of which is incorporated herein by reference.

### STATEMENT REGARDING FEDERALLY SPONSORED RESEARCH

This invention was supported in part by Grant No. DMR-02-33728 awarded by the National Science Foundation and Grant No. NCC-1-02037 awarded by NASA. The government may have certain rights in this invention.

### FIELD OF THE INVENTION

The invention relates to metal nanoparticle compositions and methods of making such nanoparticle compositions that are useful for the production of redox chemistry, electrically conductive features and catalysts. The invention also relates to the stabilization of nanoparticles in an array. The invention provides methods of synthesis of encapsulated nanoparticles and mesoporous supports and products arising there from useful as nanoparticle catalyst and in drug delivery.

### BACKGROUND

Catalysts are used in many applications such as refining and fine chemicals manufacturing. In some cases, the catalyst is necessary for a reaction to occur. In other cases, the catalyst is necessary for the process to be economically viable.

Catalysts are typically expensive for a variety of reasons. Some catalysts are expensive because they are made from precious metals, such as gold, platinum or palladium. Other catalysts are expensive because of the processing that is required to obtain a catalyst with a particular size, shape, or crystal phase. Because of the high costs of catalysts, even small improvements in catalyst performance can significantly affect the overall cost of a chemical process.

### SUMMARY

The invention relates to metal nanoparticle compositions and methods of making such nanoparticle compositions that are useful for the production of electrically conductive features and catalysts. The invention also relates to the stabilization of isolated metal nanoparticles with respect to their aggregation into larger particles or particle arrays. This is done by 1) a new method of preparation of supported metal nanoparticles, and 2) the synthesis of nanoparticle catalysts encapsulated within porous nanospheres and core/shell structures. The disclosure describes a new approach to the direct synthesis of large quantities of encapsulated nanoparticles (a heterogeneous or homogenous mixture) and the mass production of mesoporous supports that can serve as high surface area supports with pore networks that can give facile access to supported nanoparticle catalysts.

This disclosure provides a method to prepare supported metal nanoparticle catalysts. The method comprises utilizing relatively weak interactions between metal nanoparticles and the metal and metal oxides in an aprotic solvent to create a homogeneous loading of the nanoparticles. The dispersion is locked in place by calcinations so that aggregation of the nanoparticles or nucleated growth of the nanoparticles into larger particles is greatly inhibited. This assembly approach permits facile control over different parameters of a supported metal nanoparticle catalyst (e.g., particle size, size-distribution, loading), which is difficult to be realized by other preparation techniques.

The disclosure also provides methods of encapsulating nanoparticles in nanospheres to inhibit nanoparticle aggregation even at high temperatures, as well as techniques for the preparation of stable mesoporous nanospheres.

In one aspect, monodispersed organic-capped metal nanoparticles are synthesized through wet chemistry. Oxide supports are prevented from determining the size and size dispersion of metal nanoparticles, which is difficult to be realized by conventional preparation methods. In this aspect, weak interaction in appropriate solvents of metal nanoparticles and metal oxides are exploited. The strategy is then applicable to metal nanoparticles with different sizes and compositions and also to oxides with few restrictions on their physical and chemical properties.

The catalysts prepared by the described methods are efficient for the selective oxidation of alcohols, alkenes and aldehydes by using oxygen or air as oxidant under mild conditions in both gas-phase and liquid-phase. For the selective oxidation of alcohols to aldehydes and esters, the addition of carbonates or acetates significantly improves the catalytic activity of supported metal nanoparticles and the selectivity to aldehydes is enhanced by the introduction of transition metal cations or using transition metal oxide arrays to support the nanoparticles. In addition to catalysis, the prepared oxide-supported metal nanoparticles are also potential antibiotic agents and water waste treatment materials.

The disclosure provides a method of manufacturing a supported nanocatalyst. The method includes (a) providing a support material; (b) contacting the support material with a capped nanoparticle in an aprotic solvent; (c) calcining the support material comprising the capped nanoparticle to generate a supported nanocatalyst anchored to the support material. The nanoparticle used as a basis for capping can be prepared by any method known in the art. In one aspect, The support material comprises a material selected from the group consisting of metals, metal oxides, nonmetals, and polymers. In another aspect, the support material comprises a material selected from the group consisting of alumina, silica, silica gel, titania, kieselguhr, diatomaceous earth, bentonite, clay, zirconia, magnesia, zeolites, carbon black, activated carbon, graphite, and fluoridated carbon. The capped nanoparticle can comprise a noble metal. In one aspect, the capped nanoparticle comprises an alkylthiol cap. The alkyl chain of the alkylthiol can comprise from about 1 to 30 carbon atoms. In another aspect, the capped nanoparticle and support material interact by dipole-induced-dipole interactions. In a specific embodiment, the capped nanoparticle is generated by mixing a noble metal substrate with an organic solvent and an alkyl-thiol and adding a borane-complexed reducing agent. Exemplary borane-complexed reducing agents comprise tert-butylamine-borane, triethylamine-borane, morpholine-borane, ammonia-borane complex or mixtures thereof.

The disclosure also provides a supported nanocatalyst made by the methods described herein. The supported nanocatalyst compositions of the disclosure are useful as a catalyst, sensor, battery, solar cell, electronic component, optoelectronics component, molecular electronic device, support materials for chemical or biochemical or photochemical modification of nanoparticles and chromatography, light emitting device, waste treating agent and photocatalytic material.

The disclosure also provides methods of manufacturing mesoporous oxide hollow spheres and compositions thereof. The method comprises: forming silica colloidal particles; coating the silica colloidal particles with a mixture of surfactant and transition metal oxide precursor; calcining the coated silica colloidal particles to form spheres with a transition metal oxide outer layer; and etching SiO₂ from the calcined spheres. In one aspect, the metal nanoparticles or a metal oxide nanoparticles are included during formation of the silica colloidal particles. In another aspect, the metal nanoparticles are gold nanoparticles. Various metal oxides can be used such as those selected from ZrO₂, TiO₂, Al₂O₃, CeO₂, Nb₂O₅ or MnO₂.

The disclosure also provides a stable mesoporous oxide hollow sphere, the sphere comprising an outer layer of transition metal oxide is provided. In one aspect, the sphere has an inner diameter of less than 500 nm, the outer layer has a thickness of less than 50 nm, and the outer layer has a pore size of less than 5 nm. In another aspect, metal nanoparticles or metal oxide nanoparticles are encapsulated in the sphere.

The disclosure also provides a method of manufacturing a catalyst, comprising: (a) providing a dried capped nanoparticle; (b) ligand exchanging the capped nanoparticle in a solution of alcohol and an omega-mercapto-fatty acid; (c) precipitating the ligand exchanged nanoparticle; (d) dissolving the precipitated nanoparticle in an aqueous buffer; (e) contacting the dissolved nanoparticle with a metal alkoxide to obtain a mixture; (f) substantially purifying silica core-shell colloidal particles from the mixture; (g) adding a surfactant and a transition metal oxide precursor to the silica core-shell colloidal particles; (h) isolating colloidal particles; (i) calcining the particles; (j) etching the calcinated particles with a base; and (k) isolated a catalyst comprising a hollow sphere containing ligand free nanoparticles. In one aspect, the omega-mercapto-fatty acid is mercaptopropanoic acid or a mercaptoundecanoic acid. In another aspect, the precipitation is performed in an NH₄OH solution. The aqueous buffer can comprise ethanol, water and NH₄OH. In another aspect, the alkoxide moiety is selected from the group consisting of tetramethoxysilane (TMOS), tetraethoxysilane (TEOS), tetrabutoxysilane (TBOS), tetrapropoxysilane (TPOS), polydiethoxysilane, methyltrimethoxysilane, methyltriethoxysilane, ethyltriethoxysilane, octylpolysilsesquioxane and hexylpolysilsesquioxane. Various surfactants can be used including those selected from the group consisting of polyvinyl alcohol, polyvinyl propanol, Brij 30, Brij 92, Brij 97, sorbitan esters, alkylarylpolyether, alcohol ethoxylates, sodium bis(2-ethylhexyl) sulfosuccinate, and a combination thereof. Furthermore, various metal oxide precursors can be used in the methods including those selected from the group consisting of aluminum bis-ethylacetoacetate monoacetylacetonate, aluminum diacetylacetonate ethyl acetoacetate, aluminum monoacetylacetonate bis-propyl acetoacetate, aluminum monoacetylacetonate bisbutyl acetoacetate, aluminum monoacetylacetonate bishexyl acetoacetate, aluminum monoethyl acetoacetate bispropyl acetoacetonate, aluminum monoethyl acetoacetate bisbutyl acetoacetonate, aluminum monoethylacetoacetate bis-hexyl acetoacetonate, aluminum monoethylacetoacetate bisnonylacetoacetonate, aluminum dibutoxide monoacetoacetate, aluminum dipropoxide monoacetoacetate, aluminum butoxide monoethylacetoacetate, aluminum-s-butoxide bis(ethyl acetoacetate), aluminum di-s-butoxide ethylacetoacetate, aluminum-9-octadecenyl acetoacetate diisopropoxide, titanium allylacetoacetate triisopropoxide, titanium di-n-butoxide (bis-2,4-pentanedionate), titanium diisopropoxide (bis-2,4-pentanedionate), titanium diisopropoxide bis(tetramethylheptanedionate), titanium diisopropoxide bis(ethyl acetoacetate), titanium methacryloxyethylacetoacetate triisopropoxide, titanium oxide bis(pentanedionate), zirconium allylacetoacetate triisopropoxide, zirconium di-n-butoxide (bis-2,4-pentanedionate), zirconium diisopropoxide (bis-2,4-pentanedionate), zirconium diisopropoxide bis(tetramethylheptanedionate), zirconium diisopropoxide bis(ethylacetoacetate), zirconium methacryl icoxyethylacetoacetate triisopropoxide, zirconium butoxide (acetylacetate) (bisethylacetoacetate), and iron acetylacetonate. Typically the capped nanoparticle comprises a noble metal such as Au, Ag, Pt, Pd, Cu, Ni, AuCu or any combination thereof. In one aspect, the capped nanoparticle comprises an alkylthiol cap. In one aspect, the alkylthiol comprises from about 1 to 30 carbon atoms.

In a specific aspect, the disclosure provides a method of making a stable mesoporous oxide hollow sphere that encases individual noble metal nanoparticles, the method comprising: sonicating an ethanol solution comprising size monodisperse thiol-capped noble metal nanoparticles and mercaptoundecanoic acid, thereby forming mercaptoundecanoic acid conjugated-nanoparticles; precipitating the mercaptoundecanoic acid conjugated-gold nanoparticles by addition of ammonium hydroxide to the ethanol solution; washing the precipitated mercaptoundecanoic acid conjugated-gold nanoparticles with ethanol and then dissolving the mercaptoundecanoic acid conjugated-gold nanoparticles in water; adding ethanol, ammonium hydroxide and tetraethoxysilane to the aqueous solution of the mercaptoundecanoic acid conjugated-gold nanoparticles, and then stirring the mixture to form gold-silica colloidal particles; centrifuging the mixture containing the gold-silica colloidal particles and re-dispersing the pellet to form an ethanol suspension of gold-silica colloidal particles; adding Brij-30 surfactant and zirconium butoxide to the ethanol suspension, followed by stirring; isolating the gold-silica colloidal particles and calcining the colloidal particles; etching the calcined colloidal particles in sodium hydroxide, thereby removing SiO₂ components and forming hollow ZrO₂ spheres containing ligand-free gold nanoparticles.

The disclosure also includes hollow nanospheres containing an encapsulated nanoparticle therein that is obtained by one of the methods described herein.

The disclosure also provides a method of making monodispersed silica-containing nanospheres, the method comprising: providing a solution of a non-ionic surfactant in an nonpolar organic solvent; adding ammonia and a silica precursor to the solution; stirring until a precipitate of monodispersed silica-containing nanospheres is formed. In one aspect, the silica-containing nanospheres have a particle size less than 100 nm. In another aspect, the silica precursor is tetraethoxysilane and the organic solvent is cyclohexane. The non-ionic surfactant can be [octylphenoxy]-polyethoxyethanol. In some aspect, the monodispersed silica-containing nanospheres have a size range from 10 to 200 nm.

Also provided by the disclosure is a method of making monodispersed silica-containing nanospheres comprising a metal oxide, the method comprising: providing a solution of a non-ionic surfactant in an nonpolar organic solvent; adding ammonia, a silica precursor and a metal salt to the solution; stirring until a precipitate of monodispersed silica-containing nanospheres containing entrapped metal salt is formed; heating the nanospheres so as to form a metal oxide from the metal salt. The metal salt can be Ni(NO₃)₂, Co(NO₃)₂ or Fe(NO₃)₂, wherein heating results in the formation of nickel oxide, cobalt oxide or iron oxide. In one aspect, the metal salt is Ni(NO₃)₂ and the precipitated nanospheres are heated at 200° C. so as to form nickel oxide distributed inside the nanospheres. In another aspect, the metal salt is Ni(NO₃)₂ and the precipitated nanospheres are heated at 500° C. so as to form crystalline nanoparticles of nickel oxide distributed on the surface of the nanospheres. In yet another aspect, the monodispersed silica-containing nanospheres have a size range from 10 to 200 nm.

The disclosure further provides a method of making monodispersed silica-containing nanospheres comprising a nanoparticle or functional molecule, the method comprising: providing a solution of a non-ionic surfactant in an nonpolar organic solvent; adding ammonia, a silica precursor and a nanoparticle or functional molecule to the solution; stirring until a precipitate of monodispersed silica-containing nanospheres containing entrapped nanoparticle or functional molecule is formed. In one aspect, the nanoparticle is a metal nanoparticle, a metal oxide nanoparticle, or a semiconductor nanoparticle. In another aspect, the functional molecule is an organic dye or organometallic catalyst. In yet another aspect, the monodispersed silica-containing nanospheres have a size range from 10 to 200 nm.

The details of one or more embodiments are set forth in the accompanying drawings and the description below. Other features, objects, and advantages will be apparent from the description and drawings, and from the claims.

### BRIEF DESCRIPTION OF THE DRAWING

FIG. 1A-H are TEM images of 6.3 nm (A-G) and 3.5 nm (H) gold nanoparticles (5% in weight) supported on different oxides: (A) zeolite (CBV600); (B) R—Fe₂O₃; (C) TiO₂ (P25); (D) hydroxyapatite; (E) Al₂O₃; (F) ZnO; (G) fumed SiO₂; (H) SiO₂. The images were taken from the samples after thermal treatment at 300° C. in air for 1 h. All scale bars are 20 nm.

FIG. 2A shows the size-dependent catalysis of ethanol oxidation by O₂ at 200° C. Three catalysts with 3.5, 6.3, and 8.2 nm gold nanoparticles supported on SiO₂ (0.5% in weight) were used. Catalysis conditions: 1.000 g catalyst (0.5% Au on SiO₂), ethanol at 0.6 mL/hour, and O₂ at 10 mL/min.

FIG. 2B shows a comparison of current methodology to the methodology and utility of the present composition in catalysis.

FIG. 3 shows the support-dependent catalysis of ethanol oxidation by O₂ at 200° C. The catalysts were prepared by deposition of 6.3-nm Au nanoparticles on the oxide supports in 0.5% of weight. Catalysis conditions: 1.000 g catalyst (0.5% Au on oxide), ethanol at 0.6 mL/hour, and O₂ at 10 mL/min.

FIG. 4 shows the loading-dependent catalysis of ethanol oxidation by O₂ at 200° C. 6.3-nm gold nanoparticles were used for the preparation of SiO₂ supported catalyst. Catalysis conditions: 1.000 g catalyst (Au on SiO₂), ethanol at 0.6 mL/hour, and O₂ at 10 mL/min.

FIG. 5 shows TEM images of different-sized dodecanethiol-capped gold nanoparticles applied in this study: (A) 3.5±0.5 nm; (B) 6.3±0.5; (C) 8.2±0.9 nm. All scale bars are 20 nm.

FIG. 6 shows the decoloring of gold nanoparticle CHCl₃ solution after stirring with 0.100 g of different oxide powders for 30 minutes. Before mixing with oxide, each vial contains 5 mg of dodecanethiol-capped 6.3 nm gold nanoparticles in 20 mL of chloroform. The oxide materials involved in the study are as follows: TiO₂: Aeroxide P25 from Degussa; Hydroxyapatite: Reagent grade powder from Sigma-Aldrich; Al₂O₃: Aeroxide Alu C from Degussa; ZnO: Nanopowder from Aldrich; SiO₂: Aerosil 150 from Degussa; Chromatography silica gel: 60-200 mesh from J. T. Baker Inc.; WO₃: Nanopowder from Aldrich; SnO₂: Nanopowder from Sigma-Aldrich; ZrO₂: Nanopowder from Sigma-Aldrich; In₂O₃: Nanopowder from Aldrich; Zeolite: CBV600 from Zeolyst International; α-Fe₂O₃: solvothermally synthesized from DMF solution of Fe(NO₃)₃-9H₂O at 180° C.; NiO: synthesized by thermolyzing fresh nickel oxalate precipitate in air at 450° C.

FIG. 7 demonstrates the electrophoretic mobility of different dodecanethiol-capped gold nanoparticles in chloroform: (A) 6.3-nm; (b) 3.5-nm; and (C) 5.0-nm. 6.3- and 3.5-nm gold nanoparticles were prepared by amine-borane complex reduction approach described herein. While the 6.3-nm nanoparticles are mainly positively charged, the 3.5-nm nanoparticles consist of both positively charged and neutral particles. The 5.0-nm nanoparticles, synthesized through the Klabunde ripening process are neutral.

FIG. 8 shows TEM images of titania-P25 supported 6.3 nm gold nanoparticles with different loading (in weight): (A) 0.5%; (B) 1.0%; (C) 2.5%; and (D) 5.0%. The images were taken from the samples after thermal treatment at 300° C. in air for 1 hours.

FIG. 9 shows the catalysis of ethanol oxidation by O₂ by SiO₂ supported 6.3-nm gold nanoparticles (2.5% in weight) at 100° C. Catalysis conditions: 1.000 g catalyst (2.5% Au on SiO₂), ethanol at 0.6 mL/hour, O₂ at 10 mL/min.

FIG. 10 shows (A) TEM image of close-packed superlattice of 6.2-nm gold nanoparticles. (B) Optical micrograph of colloidal crystals formed directly from the reaction mixture. The inset is the dark-field micrograph. (C) Small-angle X-ray scattering and diffraction patterns of the colloidal crystals. The subscript “S” and “A” designate the Miller indices from the superlattice and atomic lattice of Au nanoparticles, respectively. The peak marked with an asterisk is from the window material of the scattering instrument.

FIG. 11 are TEM images of as-made different-sized gold nanoparticles produced by varying reaction solvent (A-B) and temperature (C-F): (A) 2.1±0.3 nm; (B) 3.5±0.3 nm; (C) 5.3±0.4 nm; (D) 6.2±0.3 nm; (E) 7.1±0.5 nm; (F) 8.3±0.5 nm. All scale bars are 20 nm.

FIG. 12 are TEM images of different metallic nanoparticles: (A) 5.5±0.3 nm Ag; (B) 6.3±0.4 nm Pd; (C) 3.8 nm±0.2 1:1 Au/Ag alloy. All scale bars are 20 nm.

FIG. 13 are ¹H NMR (top) and X-ray photoelectron (bottom) spectra of dodecanethiolcapped 6.2-nm gold nanoparticles. CD₂Cl₂ was used to prepare the NMR sample. The peaks around 5.32 and 1.53 ppm are corresponding to trace amount of CH₂Cl₂ and H₂O in the NMR solvent. The XPS sample was prepared by drop-casting the CHCl₃ solution of gold nanoparticles on a small piece of silicon wafer.

FIG. 14 are TEM images of as-made gold nanoparticles produced by using different amine-borane complex as the reducing agent: (Left) morpholine-borane; (Middle): ammonia-borane; (Right) triethylamine-borane. All scale bars are 20 nm.

FIG. 15 are TEM images of as-made gold nanoparticles produced by using different types of organic ligands as capping agent: (Left) 4-(tert-butyl)benzyl mercaptan; (Middle): dodecylamine; (Right) triphenylphosphine. All scale bars are 20 nm.

FIG. 16 are time-domain TEM images of gold nanoparticle formation: (A) 5 min; (B) 10 min; (C) 20 min; (D) 30 min; (E) 40 min; (F) 60 min. All images have the same magnification, scale bars 50 nm. The reaction was carried out at room temperature (18.5° C.) by mixing 6 mL of 0.0125M AuPPh₃Cl and 0.0250M dodecanethiol benzene solution with 6 mL of 0.125M tert-butylamine-borane complex in benzene.

FIG. 17 shows ligand-free gold nanoparticle encapsulated in hollow mesoporous ZrO₂ spheres.

FIG. 18 shows a scheme for the preparation of nanoparticle encapsulated mesoporous spheres.

FIG. 19 is a TEM image for ˜60 nm silica nanoparticles generated by the methods of the disclosure.

FIG. 20 shows a TEM image for ˜60 nm NiO—SiO₂ nanoparticles heated at 200° C. (left) and 500° C. (right).

FIG. 21 shows a TEM image for Co—O (left) and Fe—O (right) containing silica nanoparticles after heating at 800° C.

FIG. 22 shows a TEM image for silica encapsulated TiO₂ nanoparticles.

FIG. 23 shows multiple loading of silica nanospheres. Depicted are metal-oxide catalysts particles homogeneously dispersed at high loading into porous silica spheres.

FIG. 24 shows multiple loadings of gold nanoparticles in a SiO₂ nanosphere.

FIG. 25 shows Au@Microporous SiO₂@Mesoporous ZrO₂ structures generated by the methods of the disclosure.

FIG. 26 shows the generation of nanomaterial of the disclosure through impregnation and calcination. Shows is NiO@Hollow Mesoporous ZrO₂ through post-treatment.

FIG. 27 shows a porous carbon shell with a metal oxide core. The compositions can be generated by putting metal oxides such as NiO, CaO, CO₃O₄ inside a carbon sphere and coating with metal oxides such as SiO₂, Al₂O₃ and ZrO₂.

FIG. 28 is a TEM of a porous carbon shell.

### DETAILED DESCRIPTION

As used herein and in the appended claims, the singular forms “a,” “and,” and “the” include plural referents unless the context clearly dictates otherwise. Thus, for example, reference to “a nanoparticle” includes a plurality of such nanoparticles and reference to “the solvent” includes reference to one or more solvents, and so forth.

Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein.

The publications discussed above and throughout the text are provided solely for their disclosure prior to the filing date of the present application. Nothing herein is to be construed as an admission that the inventors are not entitled to antedate such disclosure by virtue of prior disclosure.

Gold nanoparticles, particularly with dimension less than 10 nm, exhibit unexpectedly high catalytic activities toward different types of reactions, a property not revealed in bulk gold. In order to obtain high catalytic activity, gold nanoparticles are generally dispersed on support materials, among which oxides are commonly used. The overall performance of a supported gold nanoparticle catalyst highly depends on the size and shape of the gold nanoparticles, the structure and properties of oxide supports, and the gold-oxide interface interactions. Although several techniques have been developed to prepare oxide-supported gold nanoparticles, they do not allow precise control over these parameters. Consequently, some reported results on gold catalysis are controversial and even partly contradictory.

In one aspect, the disclosure provides methods to prepare oxide-supported metal nanoparticle catalysts, which are applicable to acidic and basic oxides, as well as methods for designing metal nanoparticles with controlled particle size. In addition to its versatility, the approach permits facile control over different parameters of a supported metal nanoparticle catalyst (e.g., particle size, size-distribution, and loading). The effect of oxide supports in determining the size and size dispersion of nanoparticles is minimized because the nanoparticles are synthesized before they are immobilized on the oxide surface. The overall strategy allows the catalytic effect of each individual parameter involved in a supported nanoparticle catalyst to be isolated. The methodology has been used to develop green, efficient gold catalysts, useful for the selective oxidation of alcohols, aldehydes, and alkenes by oxygen.

The disclosure also provides methods and compositions comprising a porous oxide nanospheres comprising nanoparticles or other nanomaterials.

Supported nanoparticles are traditionally synthesized from single-atom gold precursors using aqueous chemistry. In the two most popular preparation methods (i.e., co-precipitation and deposition-precipitation), single-atom precursors (e.g., gold precursors) are either co-precipitated with oxide precursors or directly deposited on an oxide surface. The size and size-distribution of nanoparticles formed during the calcination process, and the degree of dispersion on the support, are highly dependent on the following conditions: (1) pH and concentration of the precursor solution; (2) isoelectric point and type of the oxide support; and (3) calcination temperature and procedure. For example, the deposition-precipitation method (DP) requires the adjustment of pH value within the range of 6-10 and is not applicable to acidic and hydrophobic supports such as SiO₂, WO₃, SiO₂—Al₂O₃, and activated carbon.

A major challenge of conventional preparations is the difficulty of controlling the average size of gold nanoparticles and their size distribution on different oxide supports. For example, gold nanoparticles in the oxide-supported gold catalysts typically have a particle-size standard deviation above 30%. Furthermore, although different loadings of nanoparticles can be achieved by changing the molar ratio of precursor to oxide support, they invariably do not have the same-sized nanoparticles.

In contrast to aqueous-solution synthesis, another method is to create supported nanoparticle catalysts in high vacuum chambers for better fundamental understanding of the origin of their catalytic activity. In both types of catalysts, however, the formation of nanoparticles is heavily influenced by the oxide supports because of the in situ formation of nanoparticles. In comparison, the more controllable formation of isolated nanoparticles has been extensively studied through different wet-chemistry approaches during the past two decades.

The large-scale synthesis of nearly monodisperse nanoparticles with size standard deviation less than 10% has been recently achieved. However, the lack of a general strategy to homogeneously disperse these nanoparticles on supports has limited their applications in catalysis.

Presynthesized gold colloidal particles have been occasionally applied as precursors for the preparation of oxide-supported gold catalysts. The presynthesized nanoparticles, which have a broad particle-size distribution, are generally deposited on oxide supports through mechanical mixing followed by evaporation. As a result, the gold nanoparticles are not homogeneously dispersed on the oxide surface. These gold nanoparticles are frequently observed to sinter after thermal treatment to remove the organic ligands. The prepared catalysts do not show advantages in terms of controlling size or dispersion of nanoparticles.

Colloidal silica can be made in different ways. Currently colloidal silica are limited in their available size range, composition and also functionality. While the size of commercial colloidal silica is mainly smaller than 50 nm, they are generally in the form of pure silica or having a trace amount of alkali ions as stabilizers. Stöber and inverse-micelle represent the most successful methods to extend the size and composition of colloidal silica. The Stöber method is effective to make silica particles larger than 100 nm. The preparation of monodispersed silica particles smaller than 100 nm by the Stöber methods typically requires the use of low concentration of silica precursors (e.g., tetraethoxysilicate (TEOS), far below 0.1M. For the production of monodispersed silica with size greater than 100 nm by the inverse-micelle higher concentrations of silica precursors can be used, however, the concentration of precursor silica in the inverse-micelle is also less than 1M. Further increase in the concentration of silica precursor is highly desirable for the mass production of monodispersed silica nanospheres.

The disclosure provides methods of preparing nanoparticles with controlled size. The method comprises mixing a noble metal substrate with an organic solvent and an alkyl-thiol in the presence of a weak reducing agent such as a borane-complexed reducing agent. The disclosure also provides methods of making oxide-supported nanocatalysts and compositions thereof, including encapsulation within nanospheres. The disclosure also provides methods of using such nanoparticles, and oxide-supported nanoparticles.

Nanoparticles useful in the disclosure can comprise a metal. For example, useful metallic nanoparticles comprise a metal which exhibits a low bulk resistivity. Non-limiting examples of metals for use in the disclosure include transition metals as well as main group metals such as, e.g., silver, gold, copper, nickel, cobalt, palladium, platinum, indium, tin, zinc, titanium, chromium, tantalum, tungsten, iron, rhodium, iridium, ruthenium, osmium and lead. Non-limiting examples of commonly used metals in nanoparticles include silver, gold, copper, nickel, cobalt, rhodium, palladium and platinum.

The compositions of the disclosure also may comprise a homogenous mixture of a particular type of nanoparticle, mixtures of two or more different metal nanoparticles (e.g., a heterogeneous mixture) and/or may comprise nanoparticles wherein two or more metals are present in a single nanoparticle, for example, in the form of an alloy or a mixture of these metals. Non-limiting examples of alloys include Ag/Au, Ag/Ni, Ag/Cu, Pt/Cu, Ru/Pt, Au/Pt and Ag/Co. Also, the nanoparticles may have a core-shell structure made of two different metals such as, e.g., a core of silver and a shell of nickel.

Ligands (i.e., caps) can be linked to metallic nanoparticles. Such caps can be non-functionalized, polyhomo- or polyhetero-functionalized. The nanoparticles can be stabilized by the attached ligands.

The weight ratio of metal in the metal nanoparticles and ligand caps carried thereon can vary over a wide range. The most advantageous ratio depends, inter alia, on factors such as the nature of the ligand cap (polymer, low molecular weight substance, etc.) and the size of the metal cores of the nanoparticles (the smaller the size the higher the total surface area thereof and the higher the amount of ligand cap that will be present).

According to an aspect of the disclosure, the metal nanoparticles exhibit a narrow particle size distribution. The metal nanoparticles for use in the disclosure typically also show a high degree of uniformity in shape. Typically, the metal nanoparticles for use in the compositions of the disclosure are substantially spherical in shape. Spherical particles are particularly advantageous because they have large surface areas.

In a one aspect of the disclosure, at least about 90%, e.g., at least about 95%, or at least about 99% of the metal nanoparticles in the compositions are substantially spherical in shape. In another aspect, the metal nanoparticle compositions are substantially free of particles in the form of flakes.

The average particle sizes and particle size distributions described herein may be measured by, e.g., SEM or TEM. Thus, the references to particle size herein refer to the primary particle size.

The nanoparticles that are useful in metal nanoparticle compositions according to the disclosure will typically have a high degree of purity. For example, the particles (without capping ligands) may include not more than about 1 atomic percent impurities, e.g., not more than about 0.1 atomic percent impurities, typically not more than about 0.01 atomic percent impurities. Impurities are those materials that are not intended in the final product and that adversely affect the properties of the final product.

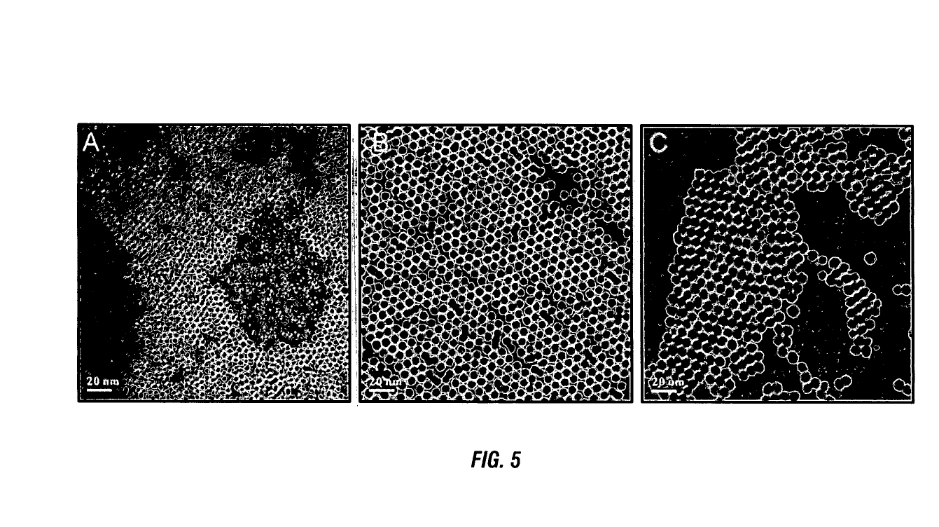

Nearly monodisperse nanoparticles are synthesized using a single-phase, one-step synthesis of the disclosure. This method includes the generation of capped nanoparticles in an organic solvent with an alkyl comprising a reactive group and a weak reducing agent (e.g., a borane complex). The narrow size-distribution of nanoparticles is readily generated by using weak reducing agents (e.g., amine-borane complexes) rather than strong reductants (e.g., NaBH₄, LiBH₄) typically used. By selecting different reaction solvents and controlling the reaction temperatures, different-sized monodisperse nanoparticles (e.g., 3.5±0.5, 6.3±0.5, and 8.2±0.9 nm) can be synthesized (FIG. 5).

The monodisperse nanoparticles are capped, in one aspect, by long-chain alkyl thiols (e.g., dodecanethiol) and soluble in organic solvents (e.g., chloroform, dichloromethane, toluene, hexanes). Ligands or caps of various chemical classes are suitable for use. Ligands include, but are not limited to, alkanethiols having alkyl chain lengths of about C₁-C₃₀. In one embodiment, the alkyl chain lengths of the alkanethiols are between about C₃ to about C₁₂.

Alkanethiols suitable for use can also be polyhomofunctionalized or polyheterofunctionalized (such as, at the Ω-position, or last position of the chain). As used herein, the term “polyhomofunctionalized” means that the same chemical moiety has been used to modify the ligand at various positions within the ligand. As used herein, the term “polyheterofunctionalized” means that different chemical moieties or functional groups are used to modify the ligands at various positions. Chemical moieties suitable for functional modification include, but are not limited to, bromo, chloro, iodo, fluoro, amino, hydroxyl, thio, phosphino, alkylthio, cyano, nitro, amido, carboxyl, aryl, heterocyclyl, ferrocenyl or heteroaryl. The ligands can be attached to the central core by various methods including, but not limited to, covalent attachment, and electrostatic attachment.

In addition to alkanethiols, various suitable ligands include, but are not limited to, polymers, such as polyethylene glycol; surfactants; detergents; biomolecules, such as polysaccharides; protein complexes; polypeptides; dendrimeric materials; oligonucleotides; fluorescent moieties and radioactive groups.

Nanoparticles, such as alkylthiol-capped gold colloids, are soluble or dispersible in a wide range of organic solvents having a large spectrum of polarity. Alternative capping agents, which include amines, carboxylic acids, carboxylates and phosphines, can extend the use to virtually any solvent.

Typically synthesized nanoparticles comprising alkyl thiols are hydrophobic owing to capping with long-chain alkyl thiols. The homogeneous dispersion of these hydrophobic nanoparticles on hydrophilic oxides can therefore be a problem.

The disclosure provides a method to circumvent this dispersion problem. The approach is based on the general concept of utilizing relatively weak interactions between metal nanoparticles and the substrates in an aprotic solvent to create a homogeneous loading of the nanoparticles. The dispersion is locked in place by calcination. For the typical aqueous preparation procedures, coulombic charge determined by the isoelectric points of the supporting oxides dominates the interaction with the metal nanoparticle precursors.

The aprotic vehicle for use in the compositions of the disclosure is typically a liquid which is capable of stably dispersing the capped metal nanoparticles, e.g., are capable of affording a dispersion that can be kept at room temperature for several days or even one, two, three weeks or months or even longer without substantial agglomeration and/or settling of the nanoparticles. To this end, it is useful for the vehicle and/or individual components thereof to be compatible with the surface of the nanoparticles, e.g., to be capable of interacting (e.g., electronically and/or sterically and/or by hydrogen bonding and/or dipole-dipole interaction, etc.) with the surface of the nanoparticles and with the capping material.

In view of the interaction between the vehicle and/or individual components thereof and the capping material on the surface of the nanoparticles, the most advantageous vehicle and/or component thereof for a composition according to the disclosure is largely a function of the nature of the capping material. For example, a capping material that comprises one or more polar groups such as, e.g., a polymer like polyvinylpyrrolidone will advantageously be combined with a vehicle which comprises (or predominantly consists of) one or more polar components (solvents) such as, e.g., a protic solvent, whereas a capping material that substantially lacks polar groups will typically be combined with a vehicle which comprises, at least predominantly, aprotic, non-polar components.

In one aspect, the vehicle of a composition according to the disclosure may comprise a mixture of at least two solvents, at least two organic solvents, e.g., a mixture of at least three organic solvents, or at least four organic solvents. The use of more than one solvent is useful because it allows one of skill in the art to adjust various properties of a composition simultaneously (e.g., viscosity, surface tension, contact angle with intended substrate etc.) and to bring all of these properties as close to the optimum values as possible.

The solvents comprised in the vehicle may be polar or non-polar or a mixture of both, mainly depending on the nature of the anti-agglomeration substance. The solvents should typically be miscible with each other to a significant extent. Non-limiting examples of solvents that are useful for the purposes of the disclosure include alcohols, polyols, amines, amides, esters, acids, ketones, ethers, water, saturated hydrocarbons, and unsaturated hydrocarbons.

Particularly in the case of a capping material that comprises one or more heteroatoms which are available for hydrogen bonding, ionic interactions, etc. (such as, e.g., O and N), it is advantageous for the vehicle of a composition according to the disclosure to comprise one or more polar solvents and, in particular, protic solvents. For example, the vehicle may comprise a mixture of at least two protic solvents, or at least three protic solvents. Non-limiting examples of such protic solvents include alcohols (e.g., aliphatic and cycloaliphatic alcohols having from 1 to about 12 carbon atoms such as, e.g., methanol, ethanol, n-propanol, isopropanol, 1-butanol, 2-butanol, sec-butanol, tert-butanol, the pentanols, the hexanols, the octanols, the decanols, the dodecanols, cyclopentanol, cyclohexanol, and the like), polyols (e.g., alkanepolyols having from 2 to about 12 carbon atoms and from 2 to about 4 hydroxy groups such as, e.g., ethylene glycol, propylene glycol, butylene glycol, 1,3-propanediol; 1,3-butanediol, 1,4-butanediol, 2-methyl-2,4-pentanediol, glycerol, trimethylolpropane, pentaerythritol, and the like), polyalkylene glycols (e.g., polyalkylene glycols comprising from about 2 to about 5 C₂₋₄ alkylene glycol units such as, e.g., diethylene glycol, triethylene glycol, tetraethylene glycol, dipropylene glycol, tripropylene glycol and the like) and partial ethers and esters of polyols and polyalkylene glycols (e.g., mono(C₁₋₆ alkyl)ethers and monoesters of the polyols and polyalkylene glycols with C₁₋₆ alkanecarboxylic acids, such as, e.g., ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether and diethylene glycol monobutyl ether (DEGBE), ethylene glycol monoacetate, diethylene glycol monoacetate, and the like).

In yet another aspect, the vehicle may comprise not more than about 5 weight percent of water, e.g., not more than about 2 weight percent, or not more than about 1 weight percent of water, based on the total weight of the vehicle. For example, the vehicle may be substantially anhydrous.

Any aprotic organic solvent can be used in the methods of the disclosure. These aprotic organic solvents may include solvents such as dioxane, dimethylformamide, dimethylacetamide, sulfolane, N-methylpyrrolidine, dimethylsulfone, dichloroethane, trichloroethane, and freons, or solvents such as dichloromethane, acetonitrile, and tetrahydrofuran.

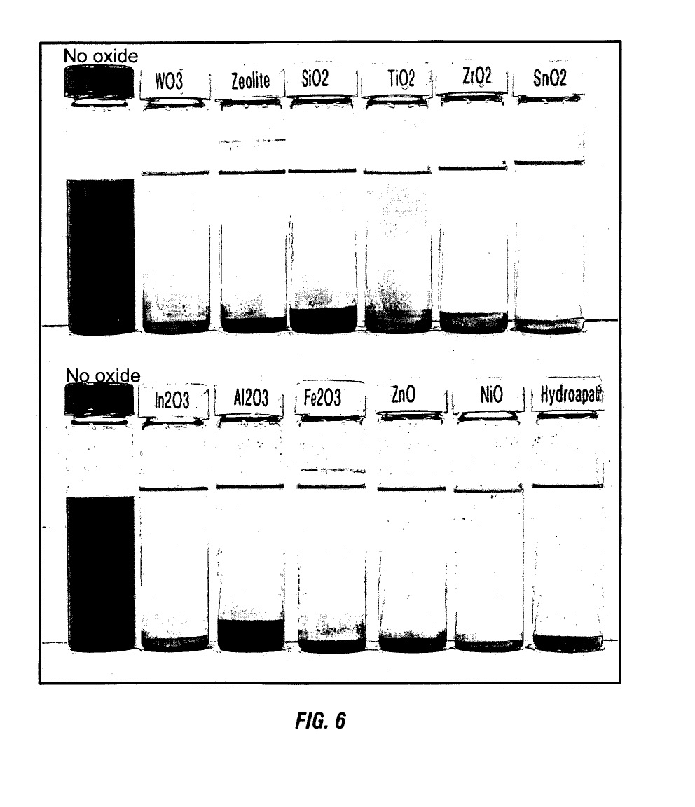

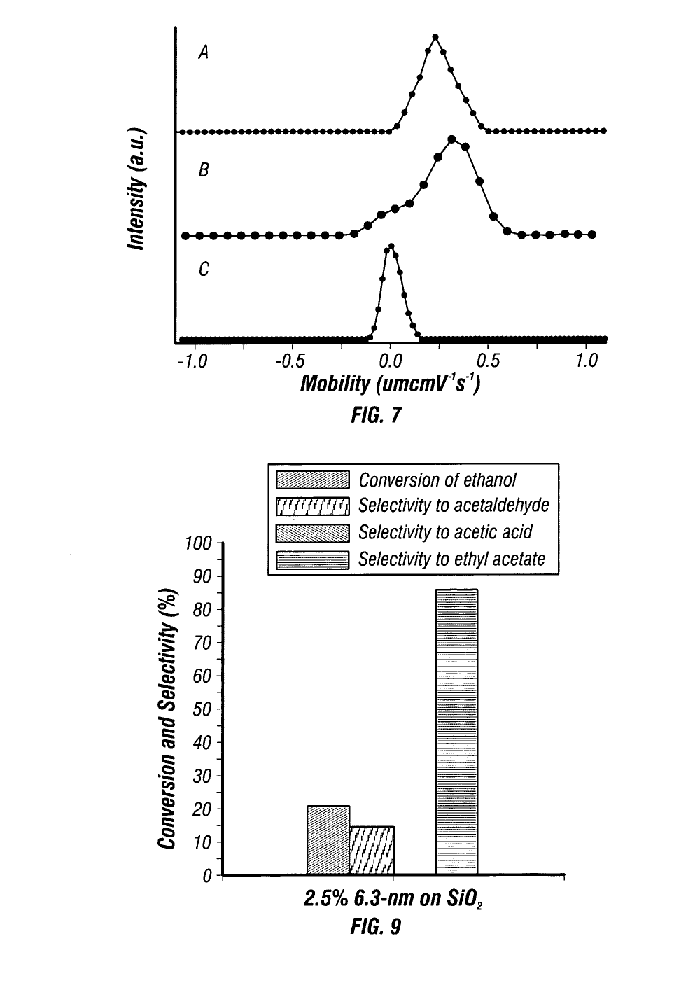

In an aprotic solvent environment, oxide surfaces have a common feature, namely abundant permanent dipoles on their surface, which means that they adsorb charged, polar, and highly polarizable species, such as metal nanoparticles, through dipole-charge, dipole-dipole, and dipole-induced dipole interactions, respectively. For example, when oxide powders (e.g., TiO₂, SiO₂, ZnO, Al₂O₃) are added to a solution of dodecanethiol-capped nanoparticles in an aprotic solvent (e.g., chloroform, methylenechloride), the gold solution is decolored while the color of the oxide powders darkens with stirring time (FIG. 6). This adsorption behavior confirms the interaction between the hydrophobic nanoparticles and the hydrophilic oxides. This interaction is rather weak and not competitive with conventional hydrogen bonding. The addition of a protic solvent (e.g., ethanol) can release the adsorbed gold nanoparticles from the oxide surface into the solution as evidenced by increased darkening of the liquid phase. This weak interaction between the nanoparticle and the metal oxide was observed for both charged and neutral organic-capped nanoparticles whose charge was characterized by electrophoretic mobility measurements (FIG. 7). Therefore, the weak interaction between oxide particles and hydrophobic metal nanoparticles most likely is due to dipole-induced dipole or dipole-charge interactions.

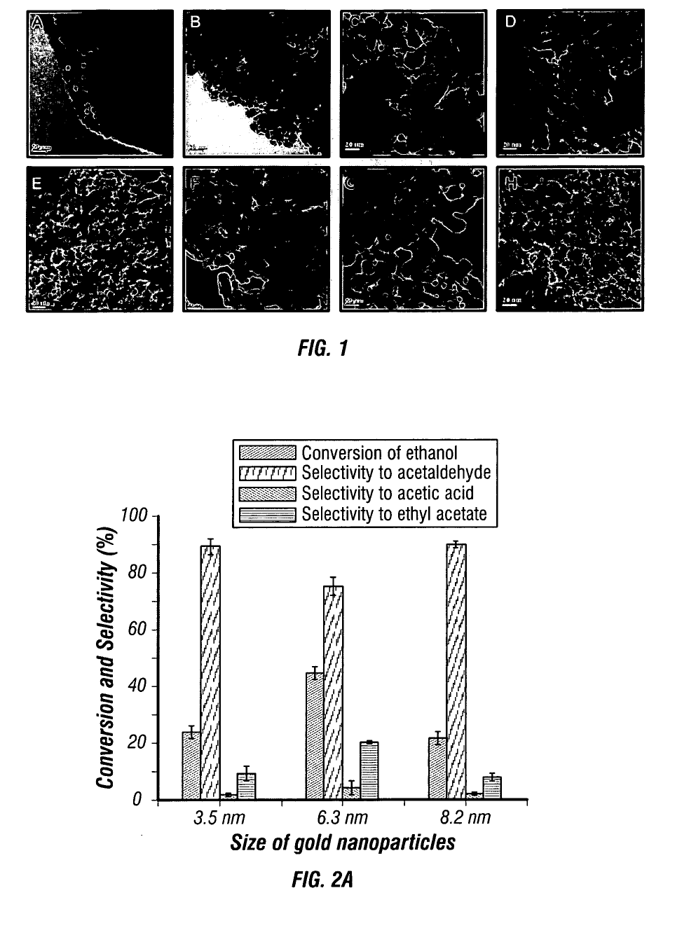

By utilizing the weak interaction between metal-oxide particles and metal nanoparticles, as illustrated in FIG. 1, nanoparticles can be deposited on different supports ranging from very acidic oxides (e.g., zeolite in its acid form) to very basic oxides (e.g., ZnO) and from insulators (e.g., SiO₂) to semiconductors (e.g., TiO₂). The adsorption and desorption of metal nanoparticles kinetically occurs on the oxide surface when a solvent is present, which allows metal particles to migrate on the oxide surface during stirring. Therefore, it is not surprising that this kinetic process leads to the homogeneous dispersion of metal nanoparticles on oxide particles.

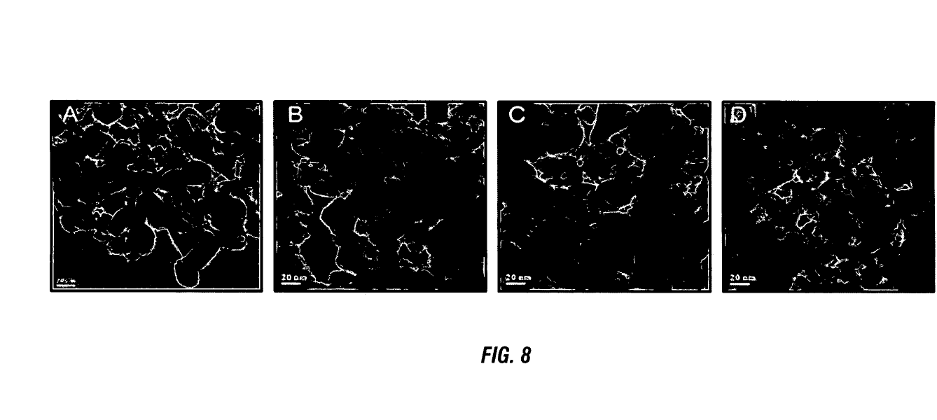

Another benefit of the methods of the disclosure is that same-sized metal nanoparticles can be easily loaded on supports in varying amounts by simply changing the amount of the oxide materials added into the metal nanoparticle solutions (FIG. 8), which is technically difficult by conventional preparation methods. The assembly approach is valid for the deposition of metal nanoparticles including, for example, gold, silver, gold-silver, platinum, palladium and the like on different oxides. The metal nanoparticles can be prepared by the methods described in this disclosure or any other reported methods.

As noted above, in one embodiment, the metal nanoparticles in the metal-oxide composites are capped by organic thiols. The capping ligands are removed by calcination, typically by heating the metal nanoparticle-oxide composites, in air at about 300° C. for about 1 h. As illustrated in FIG. 1, for both basic and acidic metal oxide supports, no obvious aggregation of gold nanoparticles is observed by TEM even though the gold nanoparticles in the calcined samples tend to wet the oxide surface during calcination. After the removal of the organic capping ligands, the nanoparticles are strongly bound to oxide supports and cannot be removed by protic organic solvents (e.g., methanol, ethanol). The supported gold nanoparticles even survive under acidic conditions (e.g., in 1 M HCl) when they are supported on nonbasic oxides (e.g., SiO₂, TiO₂).

In the method of the disclosure both weak and strong interactions between metal-nanoparticles and oxides are involved in the different steps of the preparation in order to obtain supported metal catalysts with well-defined physical and chemical properties. The weak interaction between hydrophobic metal nanoparticles and oxide nanoparticles, which exploited here for their cooperative assembly, allows controllable manipulations over both metal nanoparticles and oxide components of the catalysts since they are presynthesized individually. This assembly approach brings together the well-developed nanomaterials synthesis with catalysis and sensing applications. Furthermore, the preparation of catalysts through cooperative assembly is also desirable to create multifunctional catalysts. For example, more than two types of metal nanoparticles can be simultaneously deposited on the same oxide. While the assembly step allows more control over individual components of the catalysts, the calcination step activates and stabilizes the metal nanoparticles. The collective benefit of this approach is desirable for, e.g., the design of supported metal nanoparticle catalysts.

In one aspect, a method of confining metal nanoparticle compositions disclosed herein can involve two steps in series—first the formation of a confining pattern, that may be a physical or chemical confinement method, and second, the application of a metal nanoparticle composition to the desired confinement areas.

The metal nanoparticle composition confinement may be accomplished by applying a photoresist and then laser patterning the photoresist and removing portions of the photoresist. The confinement may be accomplished by a polymeric resist that has been applied by another jetting technique or by any other technique resulting in a patterned polymer. In one aspect, the polymeric resist is hydrophobic and the substrate surface is hydrophilic. In that case, the metal nanoparticle composition utilized is hydrophilic resulting in confinement of the composition in the portions of the substrate that are not covered by the polymeric resist.

The deposition of a metal nanoparticle composition according to the disclosure can be carried out, for example, by pen/syringe, continuous or drop on demand ink-jet, droplet deposition, spraying, flexographic printing, lithographic printing, gravure printing, other intaglio printing, and others. The metal nanoparticle composition can also be deposited by dip-coating or spin-coating, or by pen dispensing onto rod or fiber type substrates. Immediately after deposition, the composition may spread, draw in upon itself, or form patterns depending on the surface modification discussed above. In another aspect, a method is provided for processing the deposited composition using 2 or more jets or other ink sources. An example of a method for processing the deposited composition is using infiltration into a porous bed formed by a previous fabrication method. Another exemplary method for depositing the composition is using multi-pass deposition to build the thickness of the deposit. Another example of a method for depositing the composition is using a heated head to decrease the viscosity of the composition. Once deposited the support comprising the nanoparticle is calcinated.

The disclosure also provides method of generating encapsulated nanoparticle in nanospheres. The method takes advantage of the method of modulating the interaction between capped nanoparticles in weak aprotic or protic solvents and spherical oxides to form spheres comprising the nanoparticles. Using the methods described herein ultra-stable mesoporous oxide hollow spheres are generated. The oxide hollow spheres have an inner diameter ranging from 10's to 100's of nanometers. The wall of the spheres is made of 10's of nanometers thick mesoporous oxide with pores in the low nanometer range. Encapsulated in the hollow spheres are provided a variety of nanocomponents comprising metal, metal oxide nanoparticles, and drugs or other therapeutics.

For example, the melting point of gold changes with particle size (e.g., as particle size increases the melting point increases; Schmid, G., Nanoscale Materials in Chemistry, 2001 (Edited by K. J. Klabunde)). However, with a single Au nanoparticle in a core shell configuration of the disclosure, the gold nanoparticle encapsulated in the coreshell structure can be reversibly heated to 800° C. or more, giving upon cooling a gold nanoparticle of approximately the same size still encapsulated in a porous oxide sphere.

The disclosure also provides method for the mass production of monodispersed silica-containing nanospheres with controllable size, composition and also structure. Besides the mass production, a unique feature lies in its wide applicability. Different metal oxides can be easily incorporated into or onto the spheres. These introduced transition metals can be homogeneously distributed inside silica matrix, encapsulated at the core or located on the surface of the spheres. The size is tunable from about 10 nm to 200 nm, and thus the produced silica-containing spheres have high surface area and can be microporous.

The physical confinement of active nano-components in the spheres allows them to remain intact during different physical and chemical processes. The designed hollow nanospheres are highly desirable for a wide range of applications, particularly in the field of catalysis.

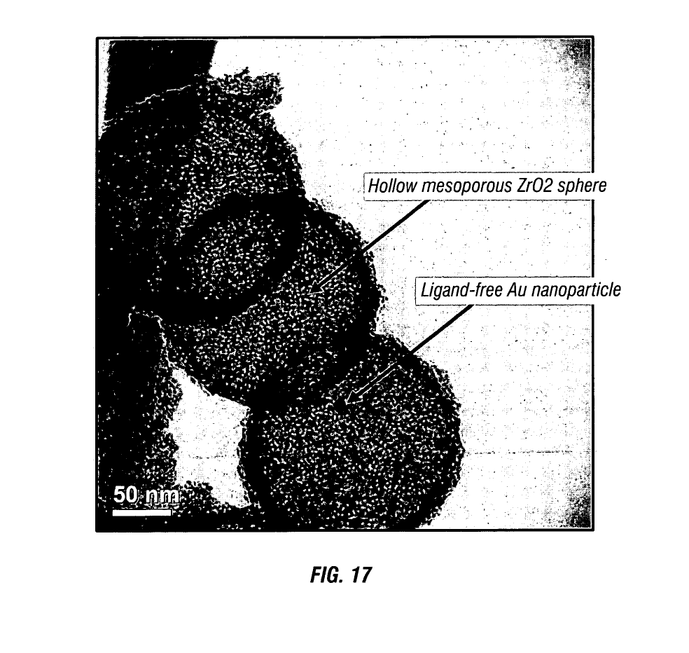

FIG. 17 shows an example of nanoparticle encapsulated hollow-spheres of the disclosure. The nanoparticle encapsulated hollow-spheres of the disclosure are generated by modifying the interaction of a capped nanoparticle with metal or silica oxides in an aprotic environments. The method includes providing a nanocatalyst preparation comprising a capped nanoparticle; ligand exchanging the capped nanoparticle in a solution of alcohol and an omega-mercaptofatty acid; precipitating the ligand exchanged nanoparticle; (d) dissolving the precipitated nanoparticle in an aqueous buffer; contacting the dissolved nanoparticle with a metal alkoxide to obtain a mixture; substantially purifying silica core-shell colloidal particles from the mixture; adding a surfactant and a metal chelate catalyst to the silica core-shell colloidal particles; isolating colloidal particles; calcining the hollow nanoparticle containing spheres; etching the calcinated particles with a base to form pores; and isolating a catalyst comprising a hollow sphere containing ligand free nanoparticles.

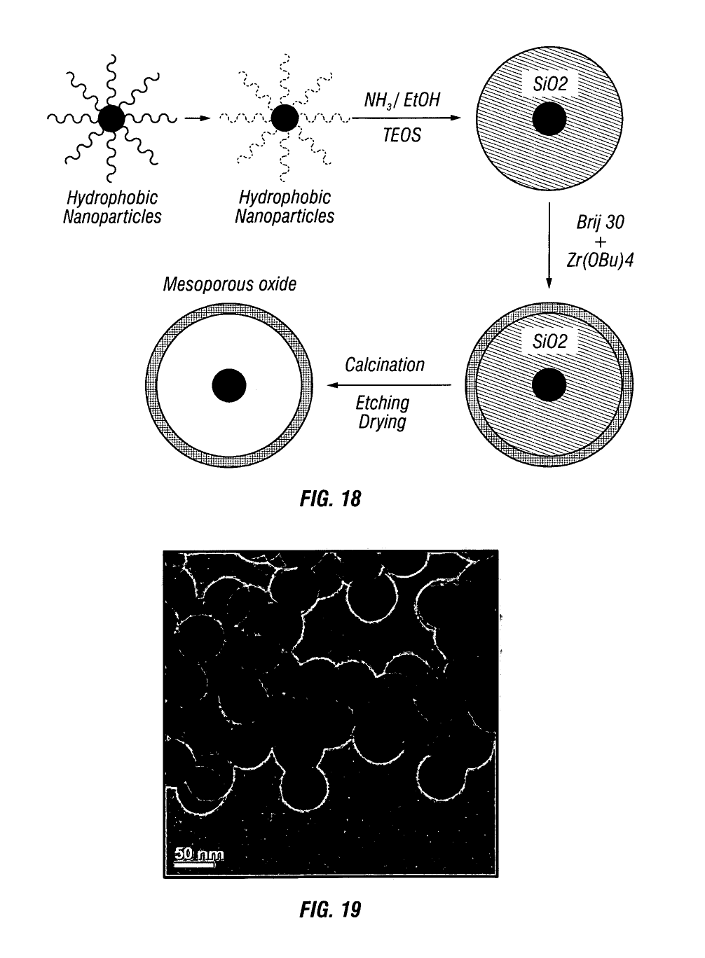

FIG. 18 depicts a scheme of this method for the synthesis of such nanoparticle-containing nanospheres. For example, dried, capped gold nanoparticles are used in a ligand exchange reaction with mercaptoundecanoic acid in ethanol with sonication. Following ligand exchange, NH₄OH is added to precipitate exchanged gold nanoparticles from the ethanol solution. After washing to remove excess amount of mercaptoundecanoic acid, the dark precipitate is dissolved in water to prepare a stock gold nanoparticle solution. A small amount of this aqueous gold solution is then mixed with ethanol, water and NH₄OH. Tetraethoxysilane is then added to the mixture. After stirring, gold silica core-shell colloidal particles are obtain through centrifugation and redispersion in ethanol. To the ethanol suspension of the gold-silica deposit is added an aqueous solution of a surfactant (e.g., Brij 30) and zirconium butoxide. After the mixture is stirred, the colloidal particles are isolated by centrifugation and kept in water. Following separation, calcination at 800-900° C. the spheres are etched with NaOH solution to generate hollow spheres of ligand-free gold nanoparticles are obtained. The prepared hollow nanospheres are stable up to at least 800° C.

Rather than mercaptoundecanoic acid other omega-mercaptofatty acids can be used. For example, mercaptopropanoic acid. In another aspect, the alkoxide is selected from the group consisting of tetramethoxysilane (TMOS), tetraethoxysilane (TEOS), tetrabutoxysilane (TBOS), tetrapropoxysilane (TPOS), polydiethoxysilane, methyltrimethoxysilane, methyltriethoxysilane, ethyltriethoxysilane, octylpolysilsesquioxane and hexylpolysilsesquioxane.

Various surfactants can also be used in the methods of the disclosure. For example, the surfactant is selected from the group consisting of polyvinyl alcohol, polyvinyl propanol, Brij 30, Brij 92, Brij 97, sorbitan esters, alkylarylpolyether, alcohol ethoxylates, sodium bis(2-ethylhexyl) sulfosuccinate, and a combination thereof.

One of skill in the art will recognize that a variety of metal chelate catalyst or transition metal oxide precursors can be used in the method of the disclosure. For example, such metal chelate catalyst or transition metal oxide precursors can be selected from the group consisting of aluminum bis-ethylacetoacetate monoacetylacetonate, aluminum diacetylacetonate ethyl acetoacetate, aluminum monoacetylacetonate bis-propyl acetoacetate, aluminum monoacetylacetonate bisbutyl acetoacetate, aluminum monoacetylacetonate bishexyl acetoacetate, aluminum monoethyl acetoacetate bispropyl acetoacetonate, aluminum monoethyl acetoacetate bisbutyl acetoacetonate, aluminum monoethylacetoacetate bis-hexyl acetoacetonate, aluminum monoethylacetoacetate bisnonylacetoacetonate, aluminum dibutoxide monoacetoacetate, aluminum dipropoxide monoacetoacetate, aluminum butoxide monoethylacetoacetate, aluminum-s-butoxide bis(ethyl acetoacetate), aluminum di-s-butoxide ethylacetoacetate, aluminum-9-octadecenyl acetoacetate diisopropoxide, titanium allylacetoacetate triisopropoxide, titanium di-n-butoxide (bis-2,4-pentanedionate), titanium diisopropoxide (bis-2,4-pentanedionate), titanium diisopropoxide bis(tetramethylheptanedionate), titanium diisopropoxide bis(ethyl acetoacetate), titanium methacryloxyethylacetoacetate triisopropoxide, titanium oxide bis(pentanedionate), zirconium allylacetoacetate triisopropoxide, zirconium di-n-butoxide (bis-2,4-pentanedionate), zirconium diisopropoxide (bis-2,4-pentanedionate), zirconium diisopropoxide bis(tetramethylheptanedionate), zirconium diisopropoxide bis(ethylacetoacetate), zirconium methacryl icoxyethylacetoacetate triisopropoxide, zirconium butoxide (acetylacetate) (bisethylacetoacetate), and iron acetylacetonate.

Accordingly, various aspect of the method are tunable to obtain a desired sphere size, encapsulated particle size, pore size and the like to obtain a wide variety of function hollow spheres. For example, the nanoparticles can have different sizes; the nanoparticles can be replaced by various metal or metal oxide particles; the inner diameter can be controlled by the diameter of silica and they're tunable by various reaction conditions; the thickness and pore size of the mesoporous layer is also adjustable; changing the composition of mesoporous to other metal oxides (e.g., TiO₂, Al₂O₃, CeO₂, Mb₂O₅, MnO₂) is possible.

In addition, hollow spheres can also be made without the pre-encapsulated nanoparticles. Such “empty” spheres can be used as nanoreactors for the post-introduction of different metal or metal oxides or nanocomponents. For example, impregnation Ni(NO₃)₂ into empty hollow porous ZrO₂ spheres followed by calcination at 400-500° C. resulting in the formation of NiO nanoparticles in ZrO₂ spheres.

In yet another aspect, the disclosure provides methods of generating ultra-stable mesoporous oxide hollow spheres. The oxide hollow spheres have an inner diameter ranging from tens to hundreds of nanometers. The wall of the spheres is made of tens-of-nanometers thick mesoporous oxides with pore size of nanometers. Encapsulated in the hollow spheres are a variety of nanocomponents, such as metal and metal oxide nanoparticles. They physical confinement of active nanocomponents in the spheres allows them to remain intact during different physical and chemical processes. The designed hollow nanospheres are highly desirable for a wide range of applications, particularly in the field of catalysis.

The disclosure provides a method for the mass production of monodispersed silica-containing nanospheres with particle size less than 100 nm by using high concentration of silica precursor. Using the techniques of the disclosure a concentration of silica precursor greater than 1M was used to generate hollow spheres in the scale of about 100 grams per liter of reaction solution. Low-cost chemical reagents are used in the methods of generating the monodispersed nanospheres. The disclosure allows the production of nanospheres that are not limited to pure silica. Incorporated in the monodispersed silica-containing nanospheres can be a wide range of functional compounds such as transitional metals, organic dyes, nanoparticles and the like. The produced silica-containing nanospheres can be microporous and have high surface area. Together with the mass production at low cost, the variety of produced monodispersed silica-containing nanospheres makes the method attractive for a wide range of applications in catalysis, biology, sensing and the like.

Any suitable method and device and combinations thereof can be used for calcination, e.g., heating in a furnace or on a hot plate, irradiation with a light source (UV lamp, IR or heat lamp, laser, etc.), combinations of any of these methods, to name just a few. Also, one or more of these steps may optionally be carried out in a reducing atmosphere (e.g., in an H₂/N₂ atmosphere for metals that are prone to undergo oxidation, especially at elevated temperature, such as e.g., Ni) or in an oxidizing atmosphere.

In addition to the methods for developing the oxide supported nanoparticles of the disclosure and they specific characteristics of the nanoparticle (e.g., size and distribution), the disclosure also provide methods and compositions useful for catalysis. The compositions of the disclosure provide useful nanoparticle distribution to facilitate and improve catalytic behavior of oxide supported nanoparticle compositions. Accordingly, methods of catalysis are also provided by the disclosure.

In addition to the selective oxidation of ethanol described herein, supported gold nanoparticles prepared by the general synthetic strategy efficiently catalyze the selective oxidation of other alcohols in gas phase by using oxygen or air as an oxidant at temperatures less than 200° C. The examined alcohols include 1-propanol, 1-butanol, 2-propanol, and 2-octanol.

The prepared supported gold nanoparticles have been successfully applied in the liquid-phase selective oxidation of alcohols, aldehydes, alkenes and alkanes by using oxygen or air as an oxidant. In a typical reaction, the catalysts are mixed with liquid reactants in a pressure reactor which is then sealed and purged by oxygen or air for three times. The temperature and O₂/air pressure are kept constants while the reaction taking place.

Under solvent-free and relative mild conditions (e.g., temperatures less than 100° C., O₂/air pressure less than 2 atms), the products of the selective oxidation of primary alcohols are aldehydes or esters while ketones can be obtained from the selective oxidation of secondary alcohols. For example, the oxidation of benzyl alcohol produces benzaldehyde or benzyl benzoate, and 2-propanol gives acetone.

Without the use of any additives, the turn over frequency (TOF) of oxide supported gold nanoparticles for the solvent-free alcohol oxidation is typically less than 100 hour⁻¹. However, the catalytic activity of supported gold nanoparticles can be dramatically enhanced when a small amount of additives are introduced. Moreover, both the efficiency and the selectivity of supported gold catalysts can be manipulated by cheap additives, which, we believe, will have a significant impact on the production of fine chemicals. With the use of a small amount of carbonates or acetates, TOF of supported gold nanoparticles can be increased by at least two magnitudes. The use of transition metal cations (i.e., Co²⁺) can improve the selectivity of primary alcohol to aldehyde. The combination of carbonate/acetate with transition metal cations enhances both the efficiency and the selectivity of support gold nanoparticle catalysts.

For example, in a 5-hour oxidation reaction of 10 mL benzyl alcohol at 100° C. and 2-atm O₂, the conversion of alcohol is less than 1% when 0.200 g of TiO₂-supported 6.3-nm gold nanoparticles (2.5% in weight) is used as the catalyst. The addition of 0.100 g of K₂CO₃ and NaCH₃COO can increase the conversion of alcohol to 46% and 43%, respectively. For the selectivity from benzyl alcohol to benzaldehyde, K₂CO₃ and NaCH₃COO give 65% and 75%, respectively. When 0.100 g of Co(CH₃COO)₂.4H₂O is used as the additive for the reaction, the selectivity to benzaldehyde is up to 94% and the conversion yield of alcohol is still as high as 46%. TOFs for oxidation of benzyl alcohol by supported gold nanoparticles can be up to 6000 h⁻¹ with the help of cheap additives. The promoting effect from the use of cheap additives would likely be due to the generation of peroxyl intermediates.

In addition to benzyl alcohol, TiO₂-supported Au nanoparticles catalyze the oxidation of ethanol, 1-propanol and 1-butanol at 80° C. into the corresponding esters when K₂CO₃ is used as the additive. Similarly, the oxidation of secondary alcohols (e.g., 2-propanol, 2-octanol) produces ketones (e.g., acetone, octan-2-one).

Supported gold nanoparticles are also applicable to the selective oxidation of aldehydes to carboxylic acids under mild conditions. The oxidation of acetaldehyde, 1-propionaldehyde, butyraldehyde and benzaldehyde has been examined by using TiO₂-supported gold nanoparticles as the catalysts. The complete conversion of aldehydes to carboxylic acids with 100% selectivity can be achieved at low temperatures (i.e., 60° C.) by using O₂ or air as the oxidant. For the oxidation of aldehydes, TOFs by supported gold nanoparticles can be higher than 10000 h⁻¹.

The selective oxidation of alkenes or other carbon-carbon double bond containing organic substances can also be catalyzed by supported gold nanoparticles. For example, when 6.3-nm gold nanoparticles are supported on SiO₂, they exhibit excellent catalytic activity for the selective oxidation of cyclohexene at 60° C.

With the help of supported gold nanoparticles as catalysts, organic halides such as halogenoalkanes can be hydrolyzed into the corresponding alcohols or ethers. For example, TiO₂-supported 6.3 nm Au nanoparticles (2.5% in weight) catalyze the hydrolysis of 1-bromobutane into 1-butanol and dibutylether in water.

The oxidative catalysis by supported metal nanoparticles might involve the generation of peroxo species as intermediates. Therefore, supported metal nanoparticles can also be used as antibiotic agents or water waste treatment materials.

The particular catalytic (selective oxidation) reaction that exemplified herein were chosen because of their commercial importance. The use of the catalysis, compositions, spheres and of the disclosure can be extended to biomass, natural gas, etc. conversion. For example, bifunctional catalysts for diesel fuel combustion that will reduce the NOX and oxidize the CO in a single or combined package using the core/shell methods and compositions described herein are feasible and contemplated. For example, the compositions of the disclosure can be used in reductions, polymerization based techniques.

The following examples are illustrative of various embodiments, methods and compositions of the disclosure. The examples are not intended to limit the disclosure and embodiments described above or elsewhere herein.

### EXAMPLES

In order to overcome the size-control problem, nearly monodisperse gold nanoparticles were synthesized using the single-phase, one-step synthesis. The narrow size-distribution of gold nanoparticles is readily generated by using weak reducing agents (amine-borane complexes) rather than strong reductants (e.g., NaBH₄, LiBH₄) typically used. By selecting different reaction solvents and controlling the reaction temperatures, three different-sized monodisperse gold nanoparticles (i.e., 3.5±0.5, 6.3±0.5, and 8.2±0.9 nm) were synthesized (FIG. 51). The stable monodisperse gold nanoparticles were capped by long-chain alkyl thiols (e.g., dodecanethiol) and soluble in organic solvents (e.g., chloroform, dichloromethane, toluene, hexanes). The synthesized gold nanoparticles are hydrophobic owing to capping with long-chain alkyl thiols. The homogeneous dispersion of these hydrophobic nanoparticles on hydrophilic oxides can therefore be a problem.

Fortunately, a route to circumvent this dispersion problem is provided. The approach is based on the general concept of utilizing relatively weak interactions between metal nanoparticles and the substrates in an aprotic solvent to create a homogeneous loading of the nanoparticles. The dispersion is then locked in place by calcination. For the usual aqueous preparation procedures, columbic charge determined by the isoelectric points of the supporting oxides dominates the interaction with the metal nanoparticle precursors. In an aprotic solvent environment, oxide surfaces have a common feature, namely abundant permanent dipoles on their surface, which means that they typically adsorb charged, polar, and highly polarizable species, such as metal nanoparticles, through dipole-charge, dipole-dipole, and dipole-induced dipole interactions, respectively. When oxide powders (e.g., TiO₂, SiO₂, ZnO, Al₂O₃) are added to a solution of dodecanethiol-capped gold nanoparticles in an aprotic solvent (e.g., chloroform, methylenechloride), the gold solution is decolored while the color of the oxide powders darkens with stirring time (FIG. 6). This adsorption behavior confirms the interaction between the hydrophobic gold nanoparticles and the hydrophilic oxides. This interaction is rather weak and not competitive with conventional hydrogen bonding. The addition of a protic solvent (e.g., ethanol) can easily release the adsorbed gold nanoparticles from the oxide surface into the solution as evidenced by increased darkening of the liquid phase. This weak interaction between the gold nanoparticle and the metal oxide was observed for both charged and neutral organic-capped gold nano-particles whose charge was characterized by electrophoretic mobility measurements (FIG. 7). Therefore, the weak interaction between oxide particles and hydrophobic metal nanoparticles most likely is due to dipole-induced dipole or dipole-charge interactions.

By utilizing the weak interaction between metal-oxide particles and metal nanoparticles, as illustrated in FIG. 1, gold nanoparticles were successfully deposited on different supports ranging from very acidic oxides (e.g., zeolite in its acid form) to very basic oxides (e.g., ZnO) and from insulators (e.g., SiO₂) to semiconductors (e.g., TiO₂). The adsorption and desorption of metal nanoparticles kinetically occurs on the oxide surface when a solvent is present, which allows metal particles to migrate on the oxide surface during stirring. Therefore, it is not surprising that this kinetic process leads to the homogeneous dispersion of metal nanoparticles on oxide particles in all the metal-oxide composites. Another benefit of the general strategy is that same-sized metal nanoparticles can be easily loaded on supports in varying amounts by simply changing the amount of the oxide materials added into the metal nanoparticle solutions (FIG. 8), which is technically difficult by conventional preparation methods. In addition to the deposition of gold nanoparticles, this assembly approach is also valid for the deposition of other metal nanoparticles (e.g., silver, gold-silver, platinum, palladium) on different oxides.

As noted above, the metal nanoparticles in the as-prepared metal-oxide composites are capped by organic thiols and do not possess catalytic properties. The capping ligands are removed by heating the prepared metal nanoparticle-oxide composites, typically in air at 300° C. for 1 h. After calcination, the ligands are decomposed and no sulfur is detected by XPS analysis. As illustrated in FIG. 1, for both basic and acidic metal oxide supports, no obvious aggregation of gold nanoparticles is observed by TEM even though the gold nanoparticles in the calcined samples tend to wet the oxide surface during calcination. After the removal of the organic capping ligands, the gold nanoparticles are strongly bound to oxide supports and cannot be removed by protic organic solvents (e.g., methanol, ethanol). The supported gold nanoparticles even survive under acidic conditions (e.g., in 1 M HCl) when they are supported on nonbasic oxides (e.g., SiO₂, TiO₂).

In summary, in the synthetic strategy described here, both weak and strong interactions between metal-nanoparticles and oxides are involved in the different steps of the preparation, which is useful in order to obtain supported metal catalysts with well-defined physical and chemical properties. The weak interaction between hydrophobic metal nanoparticles and oxide nanoparticles, which are exploited for their cooperative assembly, allows controllable manipulations over both metal nanoparticles and oxide components of the catalysts since they are presynthesized individually. The methods of the disclosure can help to bring together the well-developed nanomaterials synthesis with catalysis and sensing applications. Furthermore, the preparation of catalysts through cooperative assembly is also desirable to create multifunctional catalysts. For example, more than two types of metal nanoparticles can be simultaneously deposited on the same oxide. While the assembly step allows more control over individual components of the catalysts, the calcination step activates and stabilizes the metal nanoparticles. The collective benefit of this approach is desirable for the design of supported metal nanoparticle catalysts.

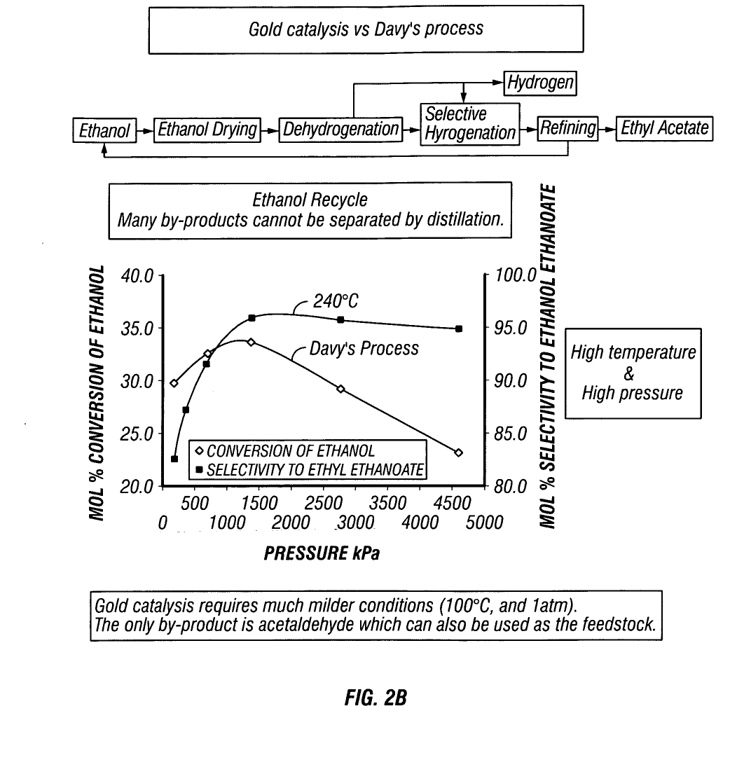

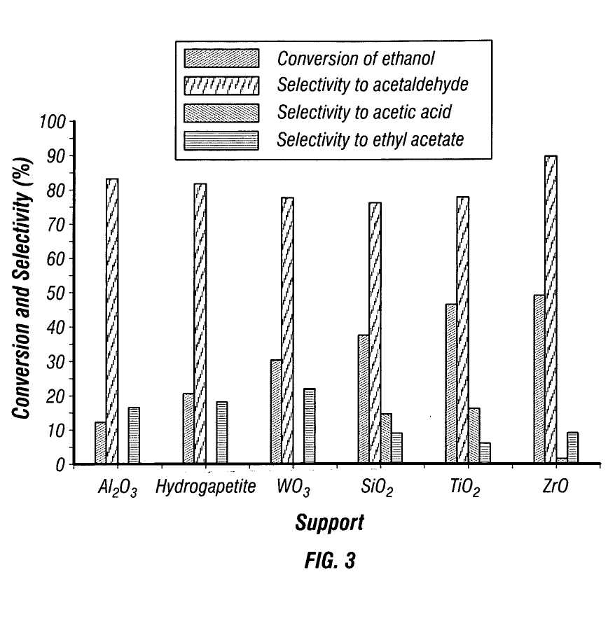

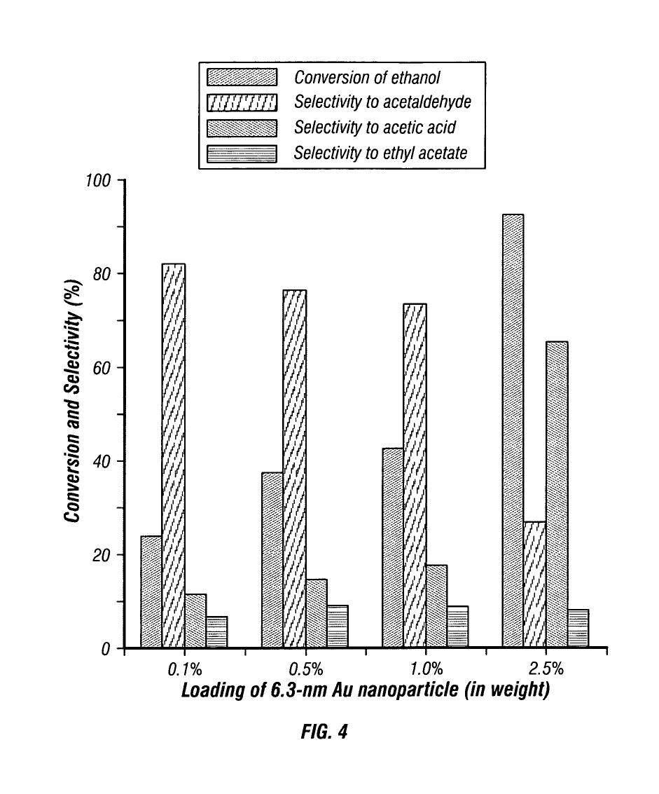

To examine the catalytic properties of the supported gold nanoparticles prepared by the methods herein, selective oxidation of ethanol by oxygen was performed. In order to study the size-dependent catalysis, three SiO2-supported catalysts with 3.5, 6.3, and 8.2 nm gold nanoparticles were prepared by depositing the nanoparticles on chromatography silica gel in 0.5% (in weight) from their corresponding chloroform solution followed by calcination in air at 300° C. for 1 h. The catalytic properties of these three catalysts at 200° C. are shown in FIG. 2A. The smallest gold nanoparticles (3.5 nm) do not exhibit the high catalytic activity observed from 6.3 nm gold nanoparticles (conversion of 45% of ethanol). Both 3.5 and 8.2 nm nanoparticles have lower ethanol conversion (24% and 22%, respectively) but much higher selectivity to acetaldehyde (90%) than do the 6.3 nm particles (75%). While 6.3 nm Au nanoparticles give TOF (turn-over frequency to acetaldehyde) of 113 h⁻¹, TOFs are 80 and 73 h⁻¹ for 3.5 and 8.2 nm particles, respectively.

After noting that 6.3 nm gold nanoparticles have a higher activity, the particles were used for ethanol oxidation under even milder conditions and found that SiO₂-supported 6.3 nm Au nanoparticles (2.5% of Au in weight) exhibit prominent catalysis with 21% ethanol conversion at 100° C. The selectivity to ethyl acetate and acetaldehyde is 86% and 14%, respectively. When the gold loading is increased to 5%, the ethanol conversion reaches 39% with 90% selectivity to ethyl acetate. This catalytic production of ethyl acetate directly from ethanol by SiO₂-supported gold nanoparticles is unusual in its mild conditions used and the high selectivity that is realized. The only byproduct is acetaldehyde, which can also be used as a feedstock for ethyl acetate. The selective oxidation of alcohols catalyzed by SiO₂-supported gold nanoparticles prepared by other methods requires much harsher conditions, which might be due to their larger size. It should also be noted that both copper- and palladium-based catalysts for the transformation of ethanol to ethyl acetate are also operated at temperatures higher than 200° C. and generate diverse byproducts.

Synthesis of different-sized dodecanethiol-capped gold nanoparticles: To prepare the dodecanethiol-capped gold nanoparticles, ClAuPPh₃ and dodecanethiol were first mixed in benzene or chloroform to form a clear solution. The reducing agent, tert-butylamine-borane complex, was then added to the mixture and stirred at certain temperature until the reduction was complete. The reduction of ClAuPPh₃ in benzene gave 6.3-nm gold nanoparticles at 55° C. and 8.2-nm at 100° C. When chloroform was used as the solvent, 3.5-nm particles were obtained from the reaction at 65° C.

Preparation of Oxide-Supported Gold Nanoparticles: Thiol-capped gold nanoparticle solids were first dissolved in an organic solvent (e.g., chloroform, methylene chloride) to form a solution with a concentration of ˜100 mg Au/100 mL solvents. Oxide powders were then added to the gold solution and stirred for 3 hours before the solids were filtered or centrifuged. The amount of oxide powders added was calculated from the desired loading of gold. The solid was then dried at 100° C. and calcined in air at 300° C. for 1 hour to remove the organic capping agents.

Electrophoretic mobility of different thiol-capped gold nanoparticles: A Zetasizer Nano ZS from Malvern instruments was used for the electrophoretic mobility measurements for different thiol-capped Au nanoparticles. The solutions were prepared by dissolving Au nanoparticles in chloroform in concentration of ˜0.25 mg/mL for the characterizations. Their electrophoretic mobilities are illustrated in FIG. 7.

Catalysis: The oxidation of alcohols was carried out in a fixed bed vertical glass reactor (inner diameter of 10 cm) equipped with a temperature controller. In a typical reaction, 1.00 g of catalyst was used. While the oxygen flow was controlled at 10 mL/minute by a flow meter, a syringe pump was used to deliver ethanol at the speed of 0.6 mL/hour. Ethanol was completely vaporized before entering the catalytic bed. The reaction products were collected by a cold trap (0° C.) for the quantitative analysis by ¹H NMR.

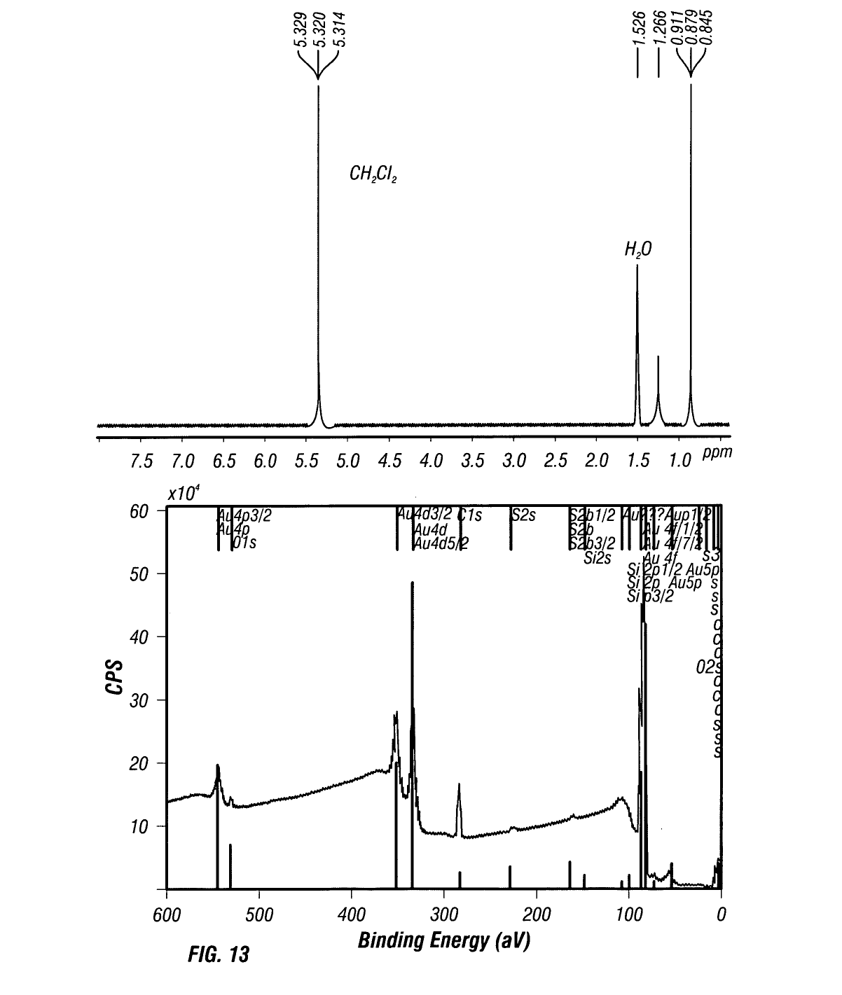

Large-scale synthesis of dodecanethiol-capped 6.2-nm Au nanoparticles: 5 mmol of AuPPh₃Cl was mixed with 2.5 ml of dodecanethiol in 400 ml benzene to form a clear solution to which 50 mmol of tert-butylamine-borane complex powders were then added in one portion. The mixture was heated with stirring at 55° C. for one hour before the mixture was cooled to room temperature. 400 mL of ethanol were then added to the reaction mixture to precipitate out gold nanoparticles as black solid powders. The solid product were separated by centrifuge, washed with access ethanol, and dried under vacuum before characterizations. This procedure gave about 1 g of monodisperse gold nanoparticles which can be redispersed in organic solvents (e.g., chloroform, hexanes, benzene) as illustrated in FIG. 5. NMR and X-ray photoelectron spectra of as-made gold nanoparticles are shown in FIG. 13.

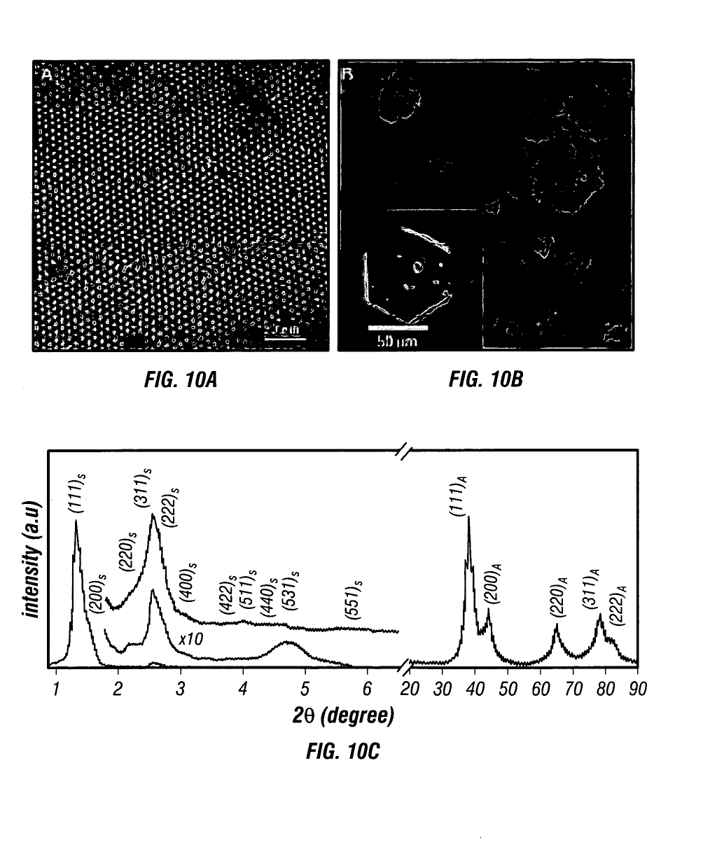

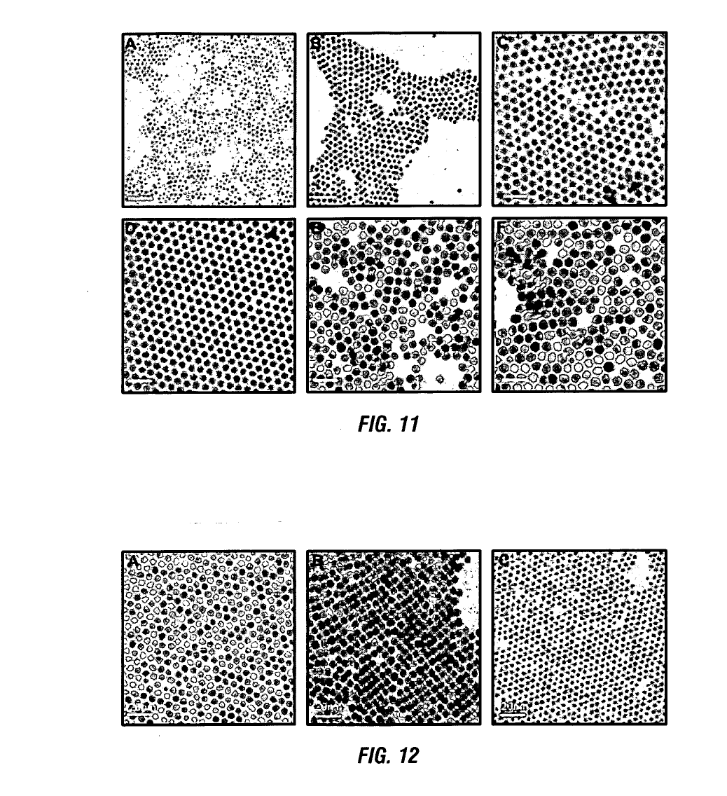

To get large colloidal crystals, a different procedure was used. Upon the completion of reaction, the reactor containing the synthesized gold nanoparticles was sealed and cooled down naturally in air. After settling for two days, large colloidal crystals were revealed at the bottom of the reactor. The formation of the colloidal crystals by slow diffusion of ethanol into the reaction mixture was also observed. The small-angle X-ray scattering and diffraction pattern is shown in FIG. 10C.

Size control by varying temperature: To study the temperature effect on the size of gold nanoparticles, the two stock solutions were prepared: (A) 20 mL benzene containing 0.25 mmol ClAuPPh₃ and 125 μL dodecanethiol; (B) 20 mL benzene containing 2.50 mmol tert-butylamine-borane complex. To a thick-wall glass vial were mixed 2 mL of solution A and 2 mL of solution B. The sealed glass vial was then stirred in a silicon oil bath which controlled the reaction temperature. At the temperatures of 55, 85 and 100° C., the mixtures were stirred for 1 hour before the mixtures were cooled. For the reaction at room temperature, the mixture was stirred for 4 hours to ensure the completion of reaction.

Preparation of dodecanethiol-capped 3.5-nm Au nanoparticles: 0.25 mmol ClAuPPh₃ was mixed together with 0.125 ml of dodecanethiol in 10 ml of CHCl₃ to form a clear solution to which 2.5 mmol of tert-butylamine-borane complex were added in the form of powder. The mixture was then heated with stirring at 65° C. for 5 hours before it was cooled down.

Preparation of dodecanethiol-capped 2.1-rim Au nanoparticles: 1.000 g of ClAuPPh₃ and 1.000 g of dodecanethiol were mixed in 50 mL of CHCl₃ to form a clear solution. Another solution, containing 1.689 g of tert-butylamine-borane, 50 mL CHCl₃ and 20 mL ethanol, was then added to the gold precursor solution. The mixture was kept stirring at room temperature for one day to complete the reaction.

Preparation of dodecanethiol-capped 5.5-nm Ag nanoparticles: In a 100-mL Erlenmeyer flask, 0.50 mmol of AgCF₃COO was dissolved in 50 mL of benzene containing 0.250 mL of dodecanethiol to form a yellow cloudy solution which was further stirred at 55° C. for 10 minutes. After 5.0 mmol tert-butylamine-borane powders were added, the mixture was kept stirring at 55° C. for 2 hours before it was cooled down.

Preparation of dodecanethiol-capped 6.3-nm Pd nanoparticles: In a 100-mL Erlenmeyer flask, 0.50 mmol of Pd(II) acetylacetone was dissolved in 50 mL of benzene containing 0.250 mL of dodecanethiol to form a clear solution which was stirred at 55° C. for five minutes. After 5.0 mmol tert-butylamine-borane powders were added, the mixture was kept stirring at 55° C. for 2 hours to complete the reaction.

Preparation of dodecanethiol-capped 3.8-nm Au/Ag alloyed nanoparticles: In a 100-mL Erlenmeyer flask, 0.25 mmol of ClAuPPh₃, 0.250 mL of dodecanethiol and 40 mL benzene were mixed to form a clear solution. The addition of 0.25 mmol AgCF₃COO led to a yellow cloudy solution. After the mixture was then stirred at 60° C. for 5 minutes, 5.0 mmol tert-butylamine-borane powders were added. The mixture was kept stirring at 60° C. one hour before it was cooled in air.

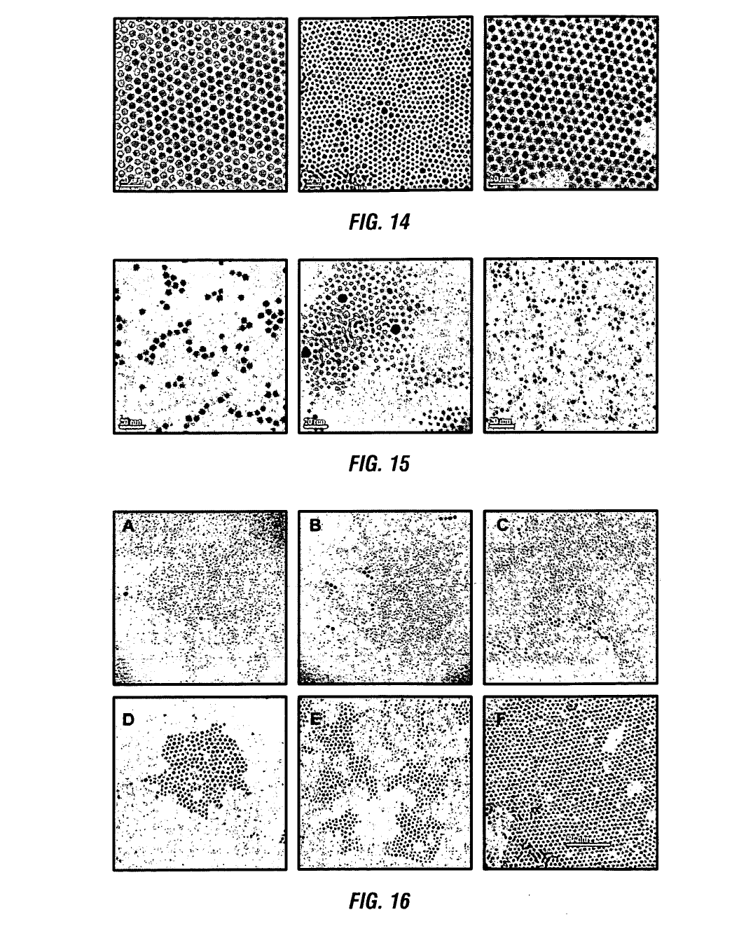

Reactions by using different borane-amine complexes: 0.10 mmol ClAuPPh₃ and 50 μL dodecanethiol mixed in 10 mL of benzene to form a clear solution before 1.0 mmol of different borane-amine complex (i.e., morpholine-borane, ammonia-borane, triethylamine-borane, tert-butylamine-borane) was added in one portion. The mixture was then stirred at 50° C. for 6 hours before the TEM sample was prepared from the reaction mixture. When borane-morpholine was used as the reducing agent, the color of the reaction mixture turned dark more slowly than those by other amine-borane complexes. In comparison, ammonia-borane reduced the gold precursors much faster and led to a broad size distribution. The size-dispersivity of the synthesized nanoparticles is illustrated in FIG. 14.

Reactions by using different types of organic ligands as capping agents: (1) 4-(tert-butyl)benzyl mercaptan capped 4.6 nm gold nanoparticles: A mixture containing 4 ml of ClAuPPh₃ benzene solution (0.0125M), 50 μL of 4-(tert-butyl)benzyl mercaptan, and 4 ml of tert-butylamine-borane benzene solution (0.125M) was prepared in a 20-mL glass vial. The mixture was then stirred at 50° C. for 3 hours to complete the reaction.

Dodecylamine capped gold nanoparticles: A mixture containing 1 ml of ClAuPPh₃ benzene solution (0.0125M), 5 mL of dodecylamine in benzene (0.050M), and 1 ml of tert-butylamine-borane benzene solution (0.125M) was prepared in a 20-mL glass vial. The mixture was then stirred at room temperature for 10 hours to complete the reaction.

PPh₃ capped gold nanoparticles: 0.025 g of ClAuPPh₃ and 0.044 g of tert-butylamine-borane powder were mixed in 20 ml of benzene to form a clear solution. The mixture was kept stirring at room temperature (˜20° C.) for 2 hours.

Generation of hollow porous spheres comprising nanoparticles. Monodispersed thiol-capped gold nanoparticles were prepared as above. The dried gold nanoparticles were then ligand exchanged with mercaptoundecanoic acid through sonication in ethanol. Following the ligand exchange, NH₄OH was added to precipitate exchanged gold nanoparticles from the ethanol solution. After washing with ethanol twice to remove excess amounts of mercaptoundecanoic acid, the dark precipitate was dissolved in water to prepare a stock gold nanoparticle solution. A small amount of this aqueous gold solution was then mixed well with certain volumes of ethanol, water and NH₄OH. Tetraethoxysilane was then added to the mixture. After stirring for several hours, gold-silica core-shell colloidal particles are obtained through centrifugation and were re-dispersed in ethanol. To the ethanol suspension of gold-silica composites was added an aqueous solution of Brij30 surfactant and zirconium butoxide. After the mixture is stirred for about 1 to several hours, the colloidal particles were isolated by centrifugation and kept in water with stirring overnight. Following separation, calcination at 800-900° C. and etching of SiO₂ components by NaOH solution was performed. The hollow spheres containing ligand-free gold nanoparticles were obtained and analyzed. The prepared hollow nanospheres are stable up to 800° C.

Synthesis of hollow mesoporous ZrO2 spheres. A mixture containing 300 mL ethanol, 60 mL water and 8 mL of 28-29% ammonia solution was first prepared. 11 mL of TEOS were added to this mixture under stirring. After 8-hour stirring, monodispersed silica nanoparticles were collected by centrifuging and washed at least twice by ethanol. The prepared silica nanospheres were then dispersed into 250 mL ethanol by sonication to form a homogenous dispersion to which 1.25 mL of Brij 30 solution (4% in water) were added. After the mixture was stirred for 1 hour, 4.5 mL of 80% zirconium butoxide in butanol were added dropwise and stirred at room temperature for 12 hours. The SiO₂—ZrO₂ composites were collected by centrifuging and dispersed into 250 mL water. The mixture was stirred for 10 hours before the solid was collected by centrifuging and calcined at 850° C. for 1 hour. After the core SiO₂ was etched out by concentrated NaOH solution (40%), the nanospheres were washed three times by water and then dried at 100° C. to give hollow mesoporous ZrO₂ spheres.

Synthesis of gold nanoparticles encapsulated in hollow mesoporous ZrO₂ spheres. 100 mg of dodecanethiol capped 6.3-nm gold nanoparticles were sonicated together with 100 mg mercaptoundecanoic acid in 10 mL ethanol for 1 hour to achieve the ligand exchange on the surface of gold nanoparticles. 0.5 mL of 28-29% ammonia solution was then added to the gold mixture to precipitate out the exchanged gold nanoparticles. The precipitates were washed twice by ethanol and then dissolved into 4 mL water to form a clear purple-red solution. 0.25 mL of this solution was then mixed together with 300 mL ethanol, 60 mL water, 8 mL 28-29% ammonia solution and stirred for 30 minutes. 11 mL of TEOS were added to this mixture under stirring. After 8-hour stirring, monodispersed Au-silica particles were collected by centrifuging and washed at least twice by ethanol. The prepared silica nanospheres were then dispersed into 250 mL ethanol by sonication to form a homogenous dispersion to which 1.25 mL of Brij 30 solution (4% in water) were added. After the mixture was stirred for 1 hour, 4.5 mL of 80% zirconium butoxide in butanol were added dropwise and stirred at room temperature for 12 hours. The Au—SiO₂—ZrO₂ composites were collected by centrifuging and dispersed into 250 mL water. The mixture was stirred for 10 hours before the solid was collected by centrifuging and calcined at 850° C. for 1 hour. After the core SiO₂ was etched out by concentrated NaOH solution (40%), the nanospheres were washed three times by water and then dried at 100° C. to give pink colored Au-hollow mesoporous ZrO₂ spheres.

Generation of monodispersed silica-containing nanospheres. An inverse micelle method was used for the mass production of the described silica-containing nanospheres with modifications. While the non-ionic surfactant ([octylphenoxylpolyethoxyethanol; NP-40/Igepal CA-630) and cyclohexane are used for the micelle formation, the hydrolysis of the silica precursors is catalyzed by ammonia. For example, 2 ml NP-40 was dissolved in 9 ml cyclohexane to form a clear solution to which 0.5 ml NH₃.H₂O and 3 ml TEOS was added. The solution was stirred at 50° C. for 2 hours in a closed container. The precipitate was then filtered and washed with ethanol before it was dried. Approximately 0.75 g of ˜60 nm silica nanospheres were obtained (see, FIG. 19).

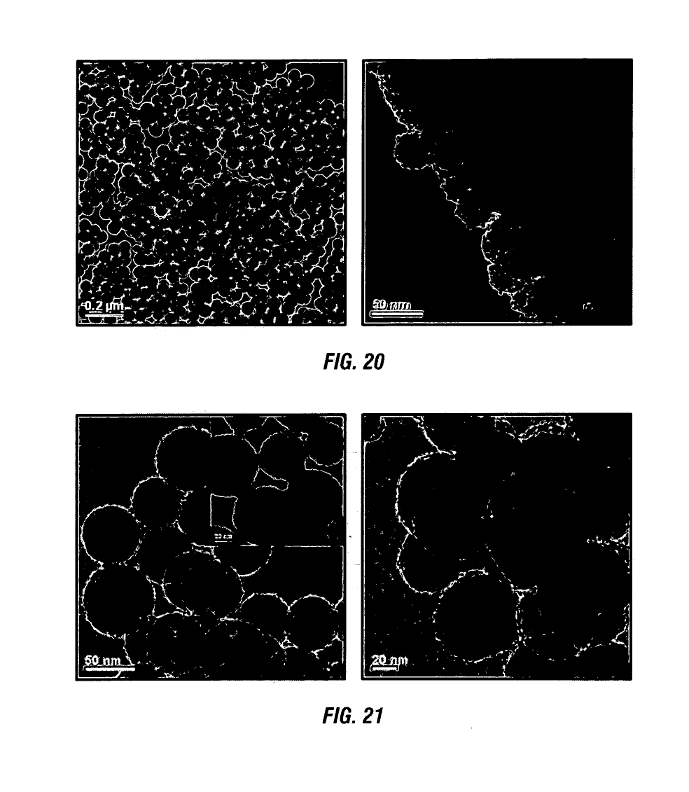

By introducing Ni(NO₃)₂, Co(NO₃)₂, Fe(NO₃)₃ into the synthesis, monodispersed transition metal containing silica nanospheres were obtained. The content of the incorporated metal oxide components can be as high as 50% in weight. FIG. 20 shows the TEM images of Ni-containing silica spheres heated at 200° C. and 500° C. Wile Ni—O is distributed in the spheres when heated at 200° C., Ni—O is located on the surface of nanospheres in the form of crystalline nanoparticles when heated at 500° C. Co—O and Fe—O containing silica nanospheres are show in FIG. 21. These Co—O and Fe—O containing silica nanospheres remain in an amorphous nature seen after heating at temperatures as high as 800° C.

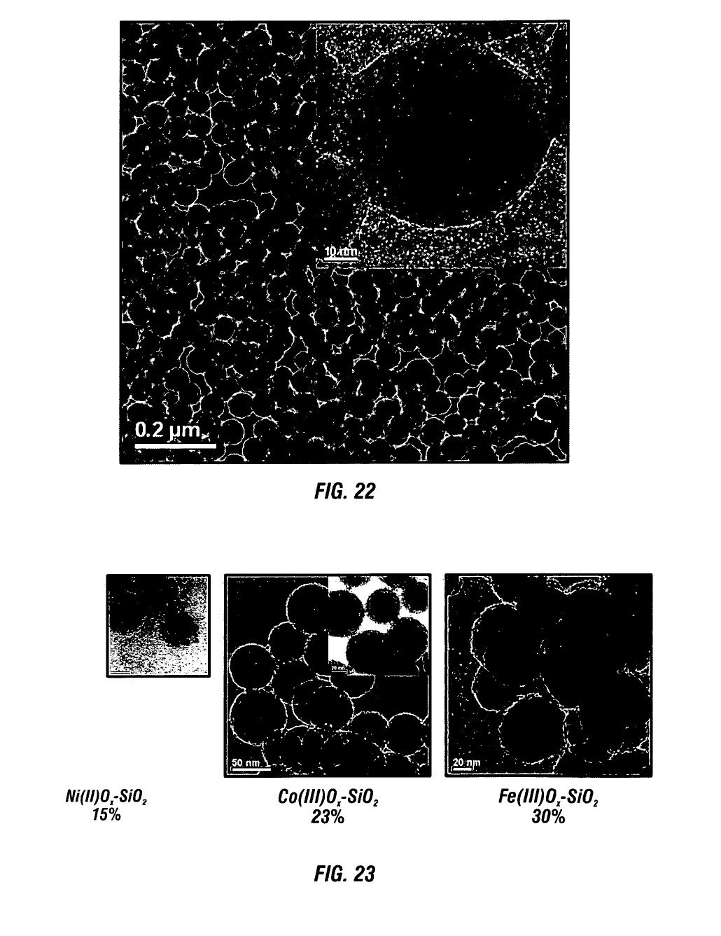

Metal oxides can also be encapsulated at the core of silica nanospheres in the form of nanoparticles. As shown in FIG. 22, TiO₂ nanoparticles were encapsulated in monodispersed silica nanospheres. The thickness of the silica shell is tunable by changing conditions.

Generally, the method is application for the mass production of various monodispersed silica-containing nanospheres. The spheres can have a size range from about 10-200 nm. The incorporated compounds in the silica nanospheres can include: transition metal oxides, they can be distributed in the silica matrix or located on the surface of the nanospheres; nanoparticles which can be metals, metal oxides or semiconductors with different functionalities, they can be encapsulated at the core of the nanospheres; and functional molecules that can be organic dyes, organometallic catalysts can be confined in the microporous silica matrix.

To examine the catalytic properties of the supported gold nanoparticles prepared by the general strategy described herein, the selective oxidation of ethanol by oxygen was examined. In order to study the size-dependent catalysis, three SiO₂-supported catalysts with 3.5, 6.3, and 8.2 nm gold nanoparticles were prepared by depositing the nanoparticles on chromatography silica gel in 0.5% (in weight) from their corresponding chloroform solution followed by calcination in air at 300° C. for 1 h. The catalytic properties of these three catalysts at 200° C. are shown in FIG. 2. The smallest gold nanoparticles (3.5 nm) do not exhibit the high catalytic activity observed from 6.3 nm gold nanoparticles (conversion of 45% of ethanol). Both 3.5 and 8.2 nm nanoparticles have lower ethanol conversion (24% and 22%, respectively) but much higher selectivity to acetaldehyde (90%) than do the 6.3 nm particles (75%). While 6.3 nm Au nanoparticles give TOF (turn-over frequency to acetaldehyde) of 113 h⁻¹, TOFs are 80 and 73 h⁻¹ for 3.5 and 8.2 nm particles, respectively.

After noting that 6.3 nm gold nanoparticles have a higher activity, the 6.3 nm nanoparticles were used for ethanol oxidation under even milder conditions. Under these conditions, the SiO₂-supported 6.3 nm Au nanoparticles (2.5% of Au in weight) exhibit prominent catalysis with 21% ethanol conversion at 100° C. The selectivity to ethyl acetate and acetaldehyde is 86% and 14%, respectively. When the gold loading is increased to 5%, the ethanol conversion reaches 39% with 90% selectivity to ethyl acetate. This catalytic production of ethyl acetate directly from ethanol by SiO₂-supported gold nanoparticles is unusual in its mild conditions used and the high selectivity that is realized. The only byproduct is acetaldehyde, which can also be used as a feedstock for ethyl acetate. The selective oxidation of alcohols catalyzed by SiO₂-supported gold nanoparticles prepared by other methods requires much harsher conditions, which might be due to their larger size. It should also be noted that both copper- and palladium-based catalysts for the transformation of ethanol to ethyl acetate are also operated at temperatures higher than 200° C. and generate diverse byproducts. This experiment demonstrates that the methods of the disclosure can be used to optimize catalysis by controlling nanoparticle size and distribution. The catalytic composition of the disclosure may comprise metallic nanoparticles in an amount of between 1% and greater than about 50 weight percent, based on the total weight of the composition.

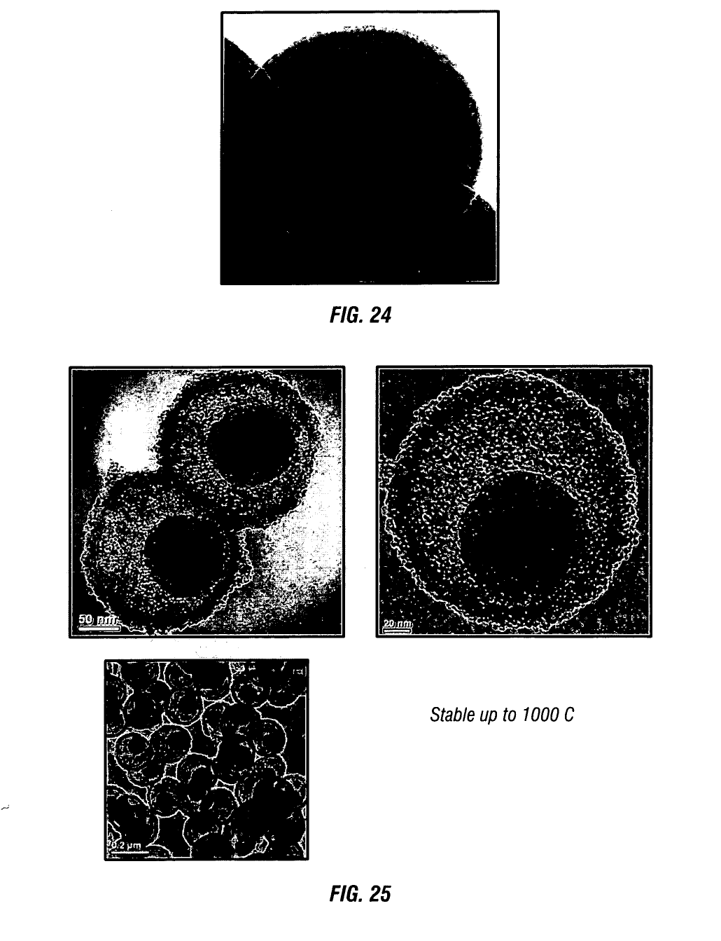

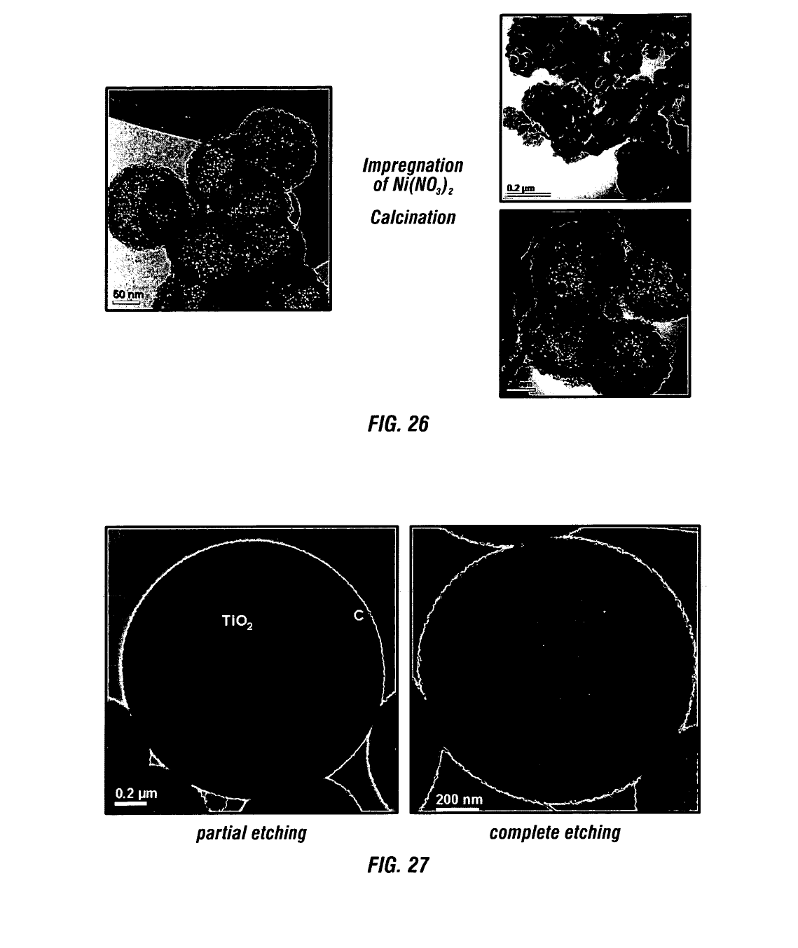

The disclosure additional provide method of generating a sphere-in-sphere compositions. Either or both of the spheres can be impregnated or encapsulate a nanoparticle. For example, FIGS. 25 and 26 shows a method of generating two different types of nanoparticles that are spatially distinct. First make a shell/core/nanoparticle structure such described herein (see, e.g., FIGS. 23 and 24). Then use post treatment to incorporate the second nanoparticle. Depending on the conditions used, a second type of nanoparticle is either on the surface of the silica core or withing the pores of the silica pore with the Au (which is shown) or other nanoparticle.

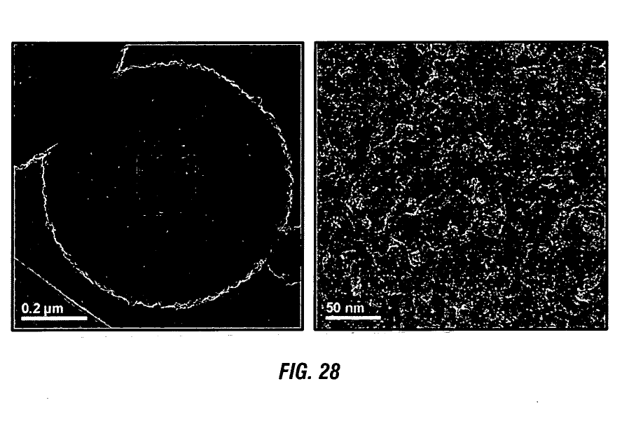

The disclosure further provides a method of generating a sphere in sphere composition. Another example of a porous carbon spherical with a metal oxide catalyst is shown in FIGS. 27 and 28. This approach involves the formation of a porous carbon coated precursor sphere (such as silica or titania), then etching away the innersphere. A metal or metal oxide catalysts can then be incorporated within the porous carbon sphere. The sphere itself can be coated with other support materials (e.g. metal oxides) and the carbon burned off if desired. This is particularly useful if the carbon sphere is needed as a synthesis template or possibly a reaction surface.

One of skill in the art will recognize that various modifications can be made to the methodology. For example, using the methodology in FIG. 18 as an example, a nanoparticle encapsulating sphere can be further ligand modified on its surface and the process repeated. For example, a nanosphere of the disclosure can be ligand modified, followed by a ligand exchange process as described herein to obtain a multi-spherical (sphere-in-sphere) nanomaterial. Each sphere may encapsulate one or more additional nanoparticles either within or on the surface.

A number of embodiments have been described. Nevertheless, it will be understood that various modifications may be made without departing from the spirit and scope of the description. Accordingly, other embodiments are within the scope of the following claims.

What is claimed is:

1. A method of manufacturing a supported nanocatalyst, comprising:
(a) providing a support material;
(b) contacting the support material with a capped nanoparticle in an aprotic solvent;
(c) calcining the support material comprising the capped nanoparticle to generate a supported nanocatalyst anchored to the support material.

2. The method of claim 1, wherein the support material comprises a material selected from the group consisting of metals, metal oxides, nonmetals, and polymers.

3. The method of claim 1, wherein the support material comprises a material selected from the group consisting of alumina, silica, silica gel, titania, kieselguhr, diatomaceous earth, bentonite, clay, zirconia, magnesia, zeolites, carbon black, activated carbon, graphite, and fluoridated carbon.

4. The method of claim 1, wherein the capped nanoparticle comprises a noble metal.

5. The method of claim 4, wherein the capped nanoparticle comprises Au, Ag, Pt, Pd, Cu, Ni, and AuCu.

6. The method of claim 1, wherein the capped nanoparticle comprises an alkylthiol cap.

7. The method of claim 6, wherein alkyl chain of the alkylthiol comprises from about 1 to 30 carbon atoms.

8. The method of claim 1, wherein the capped nanoparticle comprises a functional group selected from the group consisting of a carboxylic acid, a carbonyl, a hydroxyl, a thiol, an amine, an amide, a sulfonic acid, a sulfonyl halide, an acyl halide, a nitrile, and a nitrogen with a free lone pair of electrons.

9. The method of claim 1, wherein the capped nanoparticle and support material interact by dipole-induced-dipole interactions.

10. The method of claim 1, wherein the capped nanoparticle is generated by mixing a noble metal substrate with an organic solvent and an alkyl-thiol and adding a borane-complexed reducing agent.

11. The method of claim 10, wherein the noble metal substrate comprises ClAuPPh₃.

12. The method of claim 10, wherein the organic solvent comprises chloroform, benzene, dichloromethane, toluene or hexane.

13. The method of claim 10, wherein the alkyl-thiol comprises dodecanethiol.

14. The method of claim 10, wherein the borane-complexed reducing agent comprises tert-butylamine-borane, triethylamine-borane, morpholine-borane, ammonia-borane complex or mixtures thereof.

15. A supported monodispersed nanocatalyst made by the method of claim 1.

16. A method of using the supported nanocatalyst of claim 15 as a catalyst, sensor, battery, solar cell, electronic component, optoelectronics component, molecular electronic device, support materials for chemical or biochemical or photochemical modification of nanoparticles and chromatography, light emitting device, waste treating agent and photocatalytic material.

17. A method of making a stable mesoporous oxide hollow sphere, the method comprising:
forming silica colloidal particles;
coating the silica colloidal particles with a mixture of surfactant and transition metal oxide precursor;
calcining the coated silica colloidal particles to form spheres with a transition metal oxide outer layer; and
etching SiO₂ from the calcined spheres.

18. The method of claim 17, wherein a heterogeneous or homogenous mixture of metal nanoparticles or a metal oxide nanoparticles are included during formation of the silica colloidal particles.

19. The method of claim 18, wherein the metal nanoparticles comprise Au, Ag, Pd, Pt or any combination thereof.

20. The method of claim 17, wherein the transition metal oxide outer layer comprises ZrO₂, TiO₂, Al₂O₃, CeO₂, Nb₂O₅ or MnO₂.

21. A stable mesoporous oxide hollow sphere, the sphere comprising an outer layer of transition metal oxide.

22. The stable mesoporous oxide hollow sphere of claim 21, wherein the sphere has an inner diameter of less than 500 nm, the outer layer has a thickness of less than 50 nm, and the outer layer has a pore size of less than 5 nm.

23. The stable mesoporous oxide hollow sphere of claim 21, wherein metal nanoparticles or metal oxide nanoparticles are encapsulated in the sphere.

24. The stable mesoporous oxide hollow sphere of claim 23, wherein the metal nanoparticles wherein the metal core comprises Au, Ag, Pd, Pt or any combination thereof.

25. The stable mesoporous oxide hollow sphere of claim 23, wherein the transition metal oxide outer layer comprises ZrO₂, TiO₂, Al₂O₃, CeO₂, Nb₂O₅ or MnO₂.

26. A method of manufacturing a catalyst, comprising:
(a) providing a dried capped nanoparticle;
(b) ligand exchanging the capped nanoparticle in a solution of alcohol and an omega-mercaptofatty acid;
(c) precipitating the ligand exchanged nanoparticle;
(d) dissolving the precipitated nanoparticle in an aqueous buffer;
(e) contacting the dissolved nanoparticle with a metal alkoxide to obtain a mixture;
(f) substantially purifying silica core-shell colloidal particles from the mixture;
(g) adding a surfactant and a transition metal oxide precursor to the silica core-shell colloidal particles;
(h) isolating colloidal particles;
(i) calcining the particles;
(j) etching the calcinated particles with a base; and
(k) isolating a catalyst comprising a hollow sphere containing ligand free nanoparticles.

27. The method of claim 26, wherein the omega-mercapto-fatty acid is mercaptopropanoic acid or a mercaptoundecanoic acid.

28. The method of claim 26, wherein the precipitating is performed in an NH₄OH solution.

29. The method of claim 26, wherein the aqueous buffer comprises ethanol, water and NH₄OH.

30. The method of claim 26, wherein the alkoxide is selected from the group consisting of tetramethoxysilane (TMOS), tetraethoxysilane (TEOS), tetrabutoxysilane (TBOS), tetrapropoxysilane (TPOS), polydiethoxysilane, methyltrimethoxysilane, methyltriethoxysilane, ethyltriethoxysilane, octylpolysilsesquioxane and hexylpolysilsesquioxane.

31. The method of claim 26, wherein the purifying is by centrifugation followed by resuspension in ethanol.

32. The method of claim 26, wherein the surfactant is selected from the group consisting of polyvinyl alcohol, polyvinyl propanol, Brij 30, Brij 92, Brij 97, sorbitan esters, alkylarylpolyether, alcohol ethoxylates, sodium bis(2-ethylhexyl) sulfosuccinate, and a combination thereof.

33. The method of claim 26, wherein the transition metal oxide precursor is selected from the group consisting of aluminum bis-ethylacetoacetate monoacetylacetonate, aluminum diacetylacetonate ethyl acetoacetate, aluminum monoacetylacetonate bis-propyl acetoacetate, aluminum monoacetylacetonate bisbutyl acetoacetate, aluminum monoacetylacetonate bishexyl acetoacetate, aluminum monoethyl acetoacetate bispropyl acetoacetonate, aluminum monoethyl acetoacetate bisbutyl acetoacetonate, aluminum monoethylacetoacetate bis-hexyl acetoacetonate, aluminum monoethylacetoacetate bisnonylacetoacetonate, aluminum dibutoxide monoacetoacetate, aluminum dipropoxide monoacetoacetate, aluminum butoxide monoethylacetoacetate, aluminum-s-butoxide bis(ethyl acetoacetate), aluminum di-s-butoxide ethylacetoacetate, aluminum-9-octadecenyl acetoacetate diisopropoxide, titanium allylacetoacetate triisopropoxide, titanium di-n-butoxide (bis-2,4-pentanedionate), titanium diisopropoxide (bis-2,4-pentanedionate), titanium diisopropoxide bis(tetramethylheptanedionate), titanium diisopropoxide bis(ethyl acetoacetate), titanium methacryloxyethylacetoacetate triisopropoxide, titanium oxide bis(pentanedionate), zirconium allylacetoacetate triisopropoxide, zirconium di-n-butoxide (bis-2,4-pentanedionate), zirconium diisopropoxide (bis-2,4-pentanedionate), zirconium diisopropoxide bis(tetramethylheptanedionate), zirconium diisopropoxide bis(ethylacetoacetate), zirconium methacryl icoxyethylacetoacetate triisopropoxide, zirconium butoxide (acetylacetate) (bisethylacetoacetate), and iron acetylacetonate.

34. The method of claim 26, wherein the capped nanoparticle comprises a homogenous or heterogeneous mixtures of noble metal nanoparticles.

35. The method of claim 34, wherein the capped nanoparticle comprises Au, Ag, Pt, Pd, Cu, Ni, AuCu or any combination thereof.

36. The method of claim 26, wherein the capped nanoparticle comprises an alkylthiol cap.

37. The method of claim 36, wherein alkyl chain of the alkylthiol comprises from about 1 to 30 carbon atoms.

38. The method of claim 26, wherein the capped nanoparticle comprises a functional group selected from the group consisting of a carboxylic acid, a carbonyl, a hydroxyl, a thiol, an amine, an amide, a sulfonic acid, a sulfonyl halide, an acyl halide, a nitrile, and a nitrogen with a free lone pair of electrons.

39. A hollow nanosphere comprising a nanoparticle encapsulated therein obtained by the process of claim 26.

40. A method of making monodisperse silica-containing nanospheres, the method comprising:
providing a solution of a non-ionic surfactant in an nonpolar organic solvent;
adding ammonia and a silica precursor to the solution;
stirring until a precipitate of monodisperse silica-containing nanospheres is formed.

41. The method of claim 40, wherein the silica-containing nanospheres have a particle size less than 100 nm.

42. The method of claim 40, wherein the silica precursor is tetraethoxysilane and the organic solvent is cyclohexane.

43. The method of claim 40, wherein the non-ionic surfactant is [octylphenoxy]-polyethoxyethanol.

44. The method of claim 40, wherein the monodisperse silica-containing nanospheres have a size range from 10 to 200 nm.

45. A method of making monodisperse silica-containing nanospheres comprising a metal oxide, the method comprising:
providing a solution of a non-ionic surfactant in an nonpolar organic solvent;
adding ammonia, a silica precursor and a metal salt to the solution;
stirring until a precipitate of monodisperse silica-containing nanospheres containing entrapped metal salt is formed;
heating the nanospheres so as to form a metal oxide from the metal salt.

46. The method of claim 45, wherein the metal salt is Ni(NO₃)₂, Co(NO₃)₂ or Fe(NO₃)₂, and heating results in the formation of nickel oxide, cobalt oxide or iron oxide.

47. The method of claim 46, wherein the metal salt is Ni(NO₃)₂ and the precipitated nanospheres are heated at 200° C. so as to form nickel oxide distributed inside the nanospheres.

48. The method of claim 46, wherein the metal salt is Ni(NO₃)₂ and the precipitated nanospheres are heated at 500° C. so as to form crystalline nanoparticles of nickel oxide distributed on the surface of the nanospheres.

49. The method of claim 45, wherein the monodisperse silica-containing nanospheres have a size range from 10 to 200 nm.

50. A method of making monodisperse silica-containing nanospheres comprising a nanoparticle or functional molecule, the method comprising:
providing a solution of a non-ionic surfactant in an nonpolar organic solvent;
adding ammonia, a silica precursor and a nanoparticle or functional molecule to the solution;
stirring until a precipitate of monodisperse silica-containing nanospheres containing entrapped nanoparticle or functional molecule is formed.

51. The method of claim 50, wherein the nanoparticle is a metal nanoparticle, a metal oxide nanoparticle, or a semiconductor nanoparticle.

52. The method of claim 50, wherein the functional molecule is an organic dye or organometallic catalyst.

53. The method of claim 50, wherein the monodisperse silica-containing nanospheres have a size range from 10 to 200 nm.
